(19) United States
(12) Patent Application Publication
(10) Pub. No.: US 2017/0050789 A1
(43) Pub. Date: Feb. 23, 2017

(54) DIVISIBLE CONTAINER

(71) Applicant: Yowie Hong Kong Holdings Limited, Central (HK)

(72) Inventor: Wayne Gregory LOXTON, South Perth (AU)

(21) Appl. No.: 15/242,969

(22) Filed: Aug. 22, 2016

Related U.S. Application Data
(60) Provisional application No. 62/208,452, filed on Aug. 21, 2015.

(51) Int. Cl. B65D 65/46; A23G 3/56; B65D 8/00

(52) U.S. Cl. CPC B65D 65/463; B65D 11/02; A23G 3/563

(57) ABSTRACT

A divisible container includes first and second halves forming a capsule with a hollow interior for retaining an object. The halves may also include first and second confectionary coatings formed to the exterior for consumption by a user. The halves include spaced projections at the exterior separating the confectionary halves allowing a user to see that a non-edible component is beneath. In an embodiment, upon removal of the confectionary, projections disposed opposite the joint allow a user to separate the joint by biasing the projections away from the joint, disengaging the connection between the halves. In an embodiment, a projection extending from the first half forms a gap, and a projection extending from the second half forms a lower extension that is received within the gap when the halves are joined adding strength to the connection, and limiting rotational movement of the halves and damage to the confectionary coatings.

### CROSS-REFERENCE TO RELATED APPLICATIONS

This application is claims priority on U.S. Provisional Application Ser. No. 62/208,452, filed Aug. 21, 2015, entitled “Divisible Container,” which is herein incorporated by reference in its entirety

### BACKGROUND

The disclosed subject matter relates to a divisible container, in particular, a divisible container with a hollow interior and a confectionary coating at the exterior.

Small objects, such as toys, may be packaged in a container larger than the object making the small object easier to transport and handle. Some smaller containers are generally round and may be the size of a chicken egg. Such containers are divisible into two halves allowing access to the object therein. Some containers may include an edible confectionary at the exterior of the container that is removed by a user in order to handle the container and access the interior.

It may not be apparent to a user that a container containing a small object is beneath the confectionary coating. In addition, it may be difficult for a user to separate a container due to the hand strength of the user, the stiffness of the material used to manufacture the container, or the presence of a slick substance on the exterior of the container.

### SUMMARY

A divisible container with a longitudinal height greater than its longitudinal width includes a first half and a second half forming a capsule with a hollow interior for retaining an object. The openings of the halves are joined forming a separable joint. The container halves may also include a confectionary coating formed to the exterior for consumption by a user. The first and second halves include widely spaced projections extending from the outer surface separating the confectionary halves longitudinally, and allowing a user to see that a non-edible component is beneath the confectionary coating. Once the confectionary coating is removed from the capsule, projections disposed opposite the joint allow a user to separate the joint by biasing the projections away from the joint, disengaging the connection between the first and second halves.

In an embodiment, the projections are spherical. In an embodiment, the projections are tubular.

In an embodiment, the halves form a separable joint that circumscribes the container longitudinally.

In an embodiment, the halves form a separable joint that circumscribes the container transversely about the midsection.

In an embodiment, the divisible container first and second halves include widely spaced projections extending from the outer surface separating the confectionary halves longitudinally, and allowing a user to see that a non-edible component is beneath the confectionary coating. A first projection extending from the first half adjacent the opening forms a gap, and a second projection extending from the second half adjacent the opening forms a lower extension that is received within the gap when the halves are joined.

In an embodiment, the first half opening interior forms a continuous upper groove and a lower groove interrupted by a gap, and the second half opening exterior forms a continuous upper ridge and a lower ridge interrupted by the lower extension for releasably connecting the first half and second half.

### BRIEF DESCRIPTION OF THE DRAWINGS

The drawings constitute a part of this specification and include exemplary embodiments of the disclosed subject matter and illustrate various objects and features thereof.

FIG. 1 is a perspective view of an embodiment of a capsule including features of the disclosed subject matter with the first and second halves are separated.

FIG. 2 is an enlarged view of the capsule of FIG. 1.

FIG. 3 is a front view of the capsule of FIG. 1.

FIG. 4 is a right side view of the capsule of FIG. 1 with the first and second halves joined.

FIG. 5 is a front view of the capsule of FIG. 1 with the first and second halves joined, and the right side of the second half separated from the right side of the first half.

FIG. 6 is a right side view of the capsule of FIG. 1 with the first and second halves joined, and the right side of the second half separated from the right side of the first half.

FIG. 7 is a left side view of the capsule of FIG. 1 with the first and second halves joined.

FIG. 8 is a perspective view of the capsule of FIG. 1 with a confectionary coating and a covering.

FIG. 9 is cross-sectional view of the second half with an object at the interior.

FIG. 10 is a perspective view of an alternative embodiment of a capsule including features of the disclosed subject matter with the first and second halves are separated.

FIG. 11 is an enlarged view of the capsule of FIG. 10.

FIG. 12 is a front view of the capsule of FIG. 10.

FIG. 13 is a right side view of the capsule of FIG. 10 with the first and second halves joined.

FIG. 14 is a left side view of the capsule of FIG. 10.

FIG. 15 is a perspective view of an alternative embodiment of a capsule including features of the disclosed subject matter with the first and second halves are separated.

FIG. 16 is an enlarged view of the capsule of FIG. 15.

FIG. 17 is a front view of the capsule of FIG. 15.

FIG. 18 is a right side view of the capsule of FIG. 15 with the first and second halves joined.

FIG. 19 is a left side view of the capsule of FIG. 15.

FIG. 20 is a perspective view of an alternative embodiment of a capsule including features of the disclosed subject matter with the first and second halves separated.

FIG. 21 is an enlarged view of the capsule of FIG. 20.

FIG. 22 is a front view of the capsule of FIG. 20 with the first and second halves joined.

FIG. 23 is a right side view of the capsule of FIG. 20 with the first and second halves joined.

FIG. 24 is a perspective view of the capsule of FIG. 20 with a confectionary coating and a covering.

FIG. 25 is cross-sectional view of the first and second halves with an object at the interior.

FIG. 25A is an enlarged cross-sectional view of the connection between the first and second halves.

FIG. 26 is a perspective view of an alternative embodiment of a capsule including features of the disclosed subject matter with the first and second halves separated.

FIG. 27 is an enlarged view of the capsule of FIG. 26.

FIG. 28 is a front view of the capsule of FIG. 26.

FIG. 29 is a right side view of the capsule of FIG. 26 with the first and second halves joined.

FIG. 30 is a left side view of the capsule of FIG. 26.

FIG. 31 is a perspective view of the capsule of FIG. 26 with a confectionary coating and a covering.

FIG. 32 is cross-sectional view of the second half with an object at the interior.

FIG. 33 is a perspective view of an alternative embodiment of a capsule including features of the disclosed subject matter with the first and second halves separated.

FIG. 34 is an enlarged perspective view of the capsule of FIG. 33 showing the flanges.

FIG. 35 is an enlarged perspective view of the capsule of FIG. 34 showing the flanges.

FIG. 36 is a front view of the capsule of FIG. 33 with the first and second halves joined.

FIG. 37 is a right side view of the capsule of FIG. 33 with the first and second halves joined.

FIG. 38 is a perspective view of the capsule of FIG. 33 with a confectionary coating and a covering.

FIG. 39 is cross-sectional view of the first and second halves of the capsule of FIG. 33 with an object at the interior.

### DETAILED DESCRIPTION

The disclosed subject matter includes a capsule having a first half and a second half that are jointed to form a resalable divisible container with a hollow interior for retaining an object, such as a toy. Each half forms widely spaced projections at the exterior. The capsule may be formed from semi-rigid materials, including plastic. The capsule may include a confectionary coating separated by the projections. The projections provide an indication to a user that an object, such as the capsule, is beneath the confectionary coating, and in certain embodiments, assist a user in separating the container to access the interior.

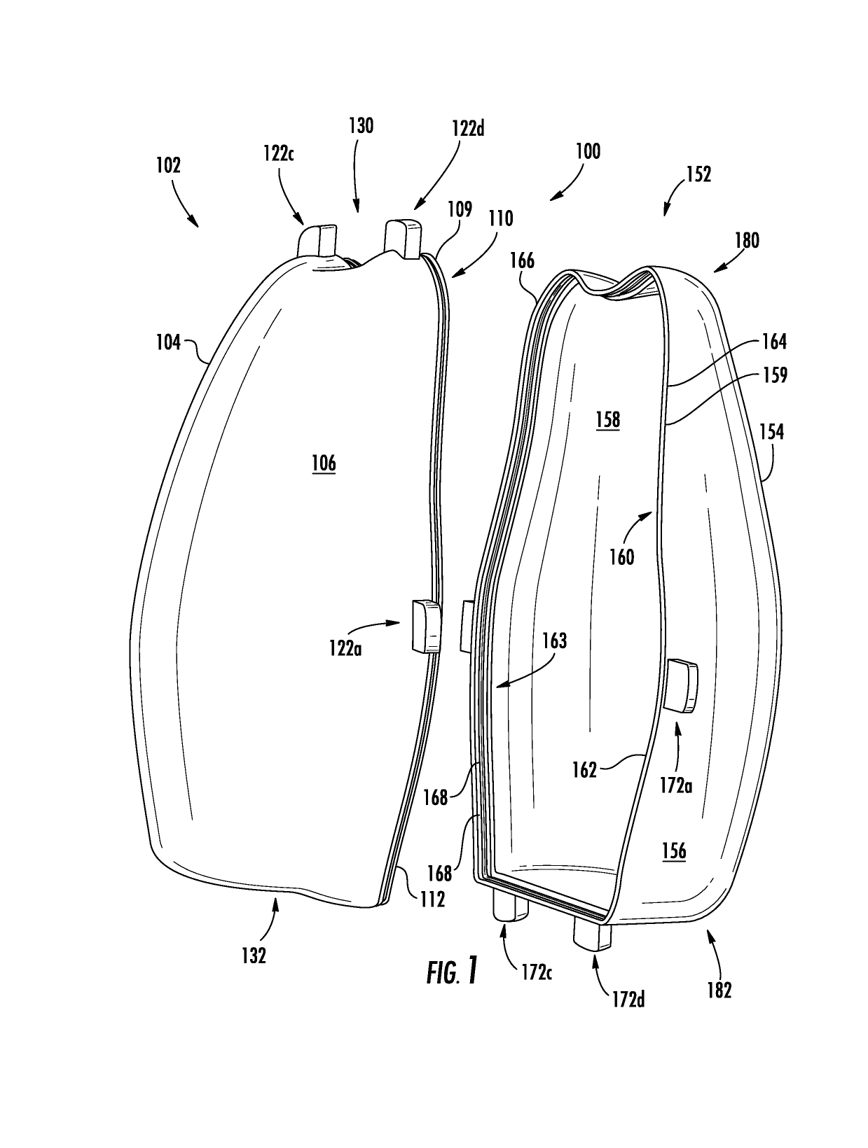

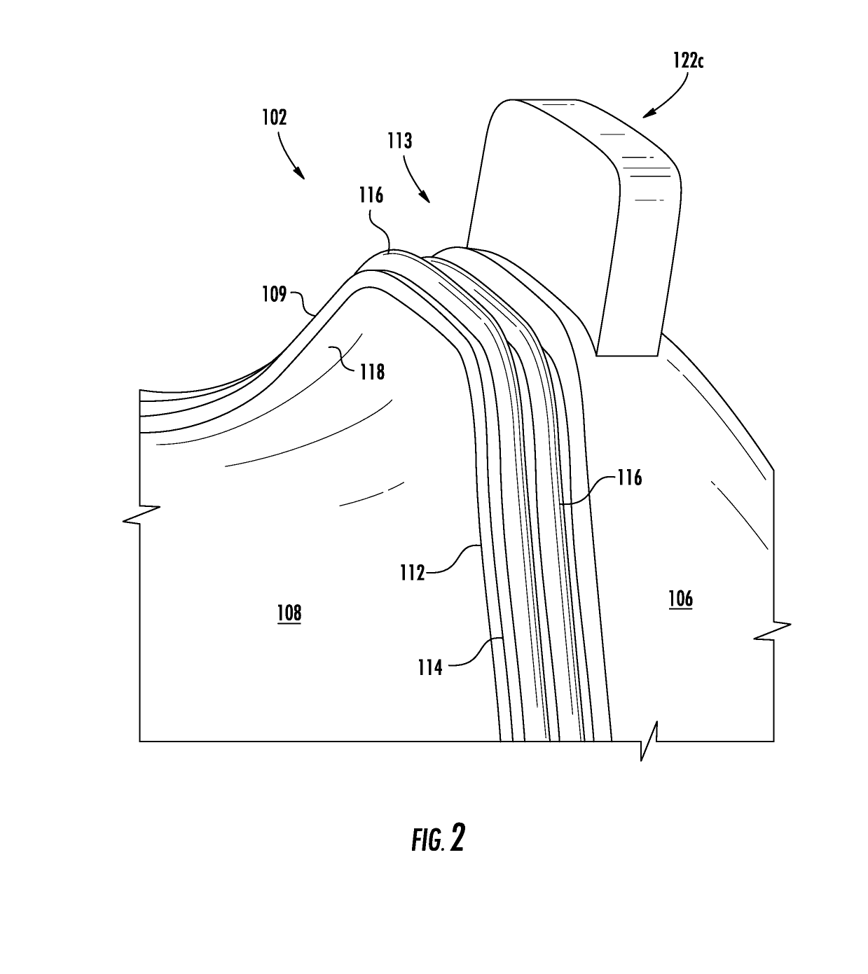

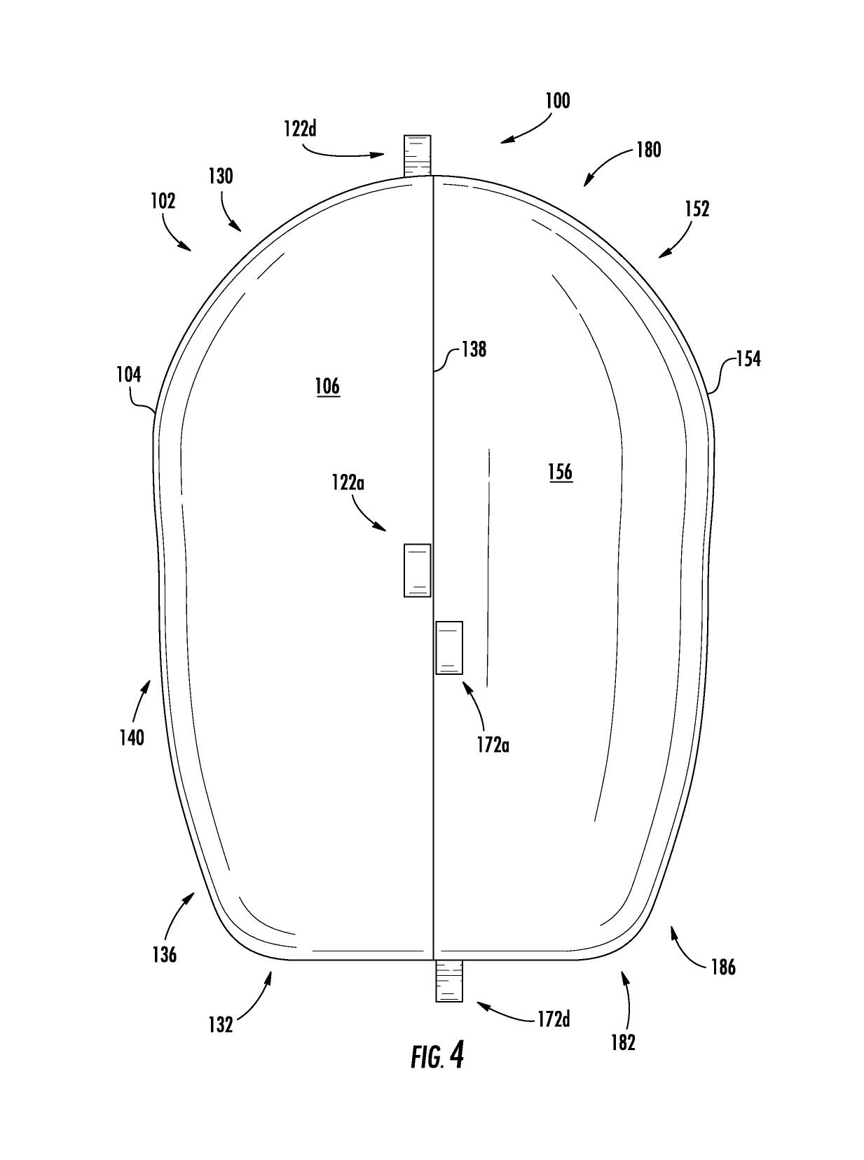

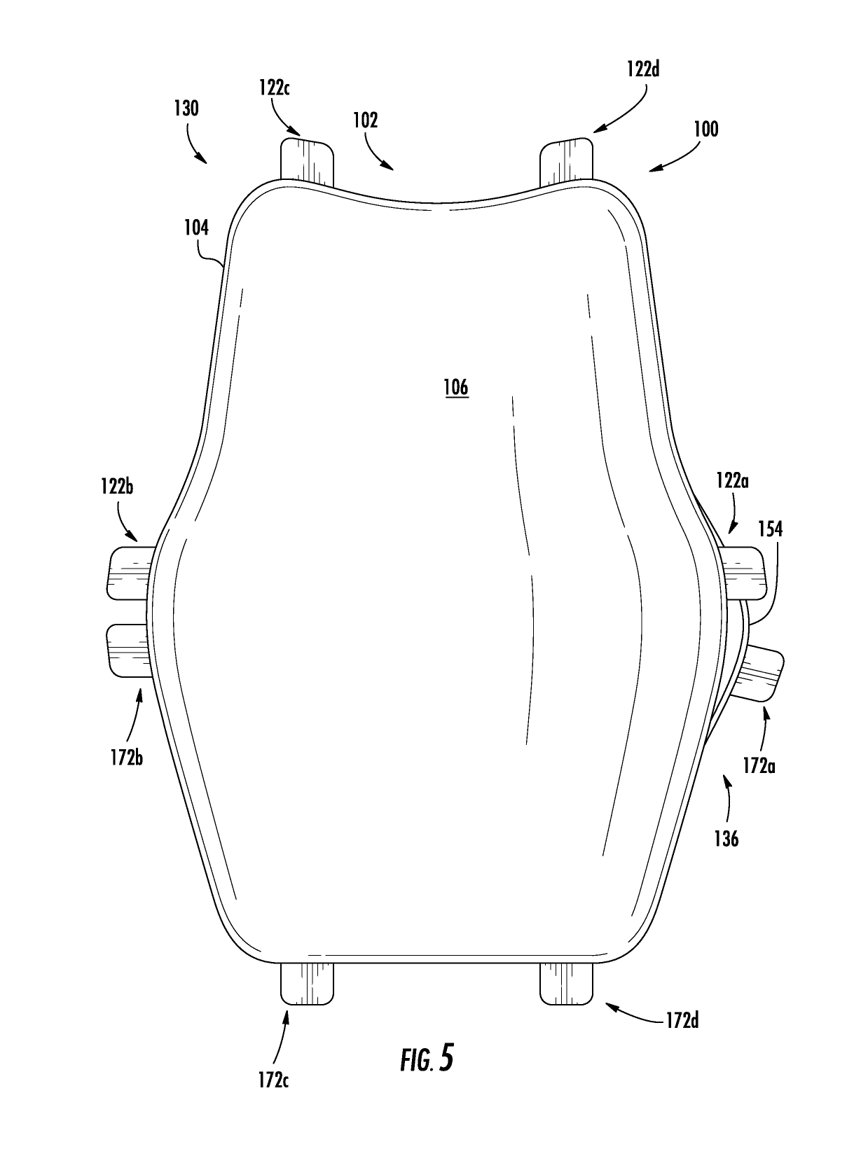

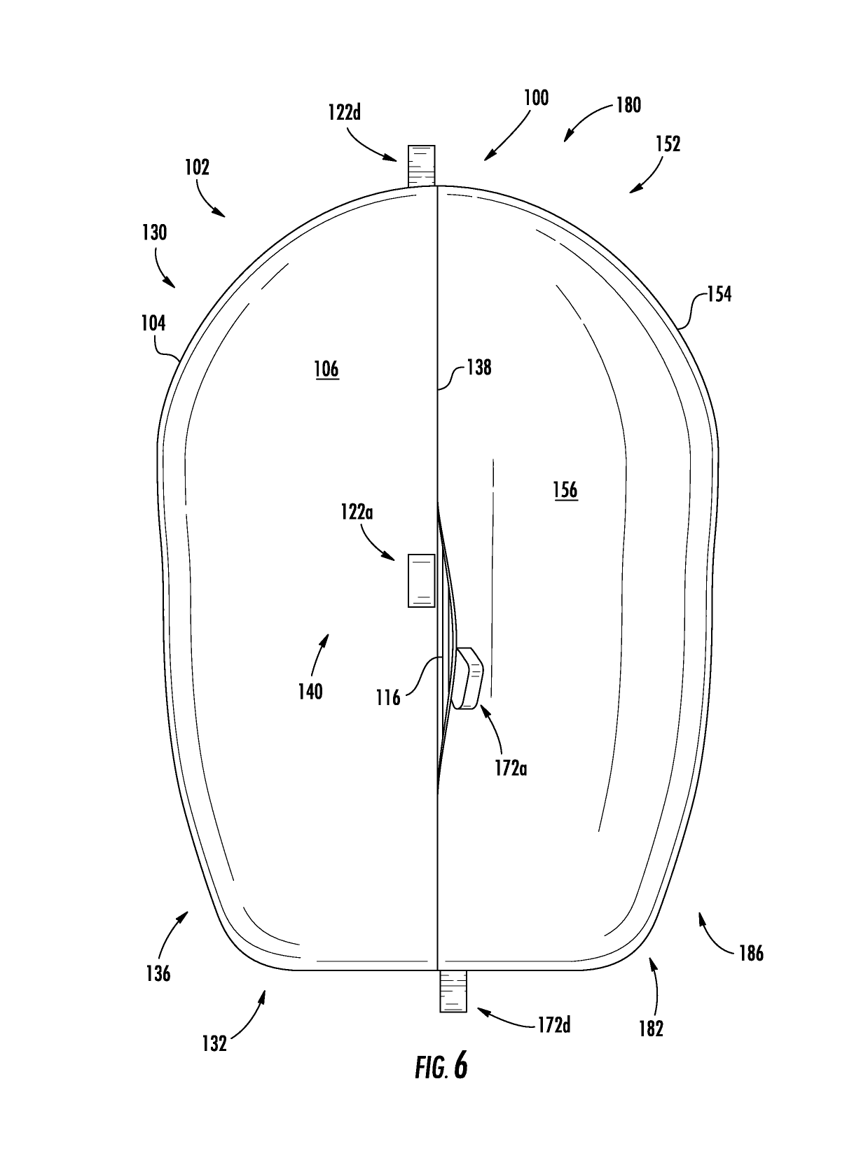

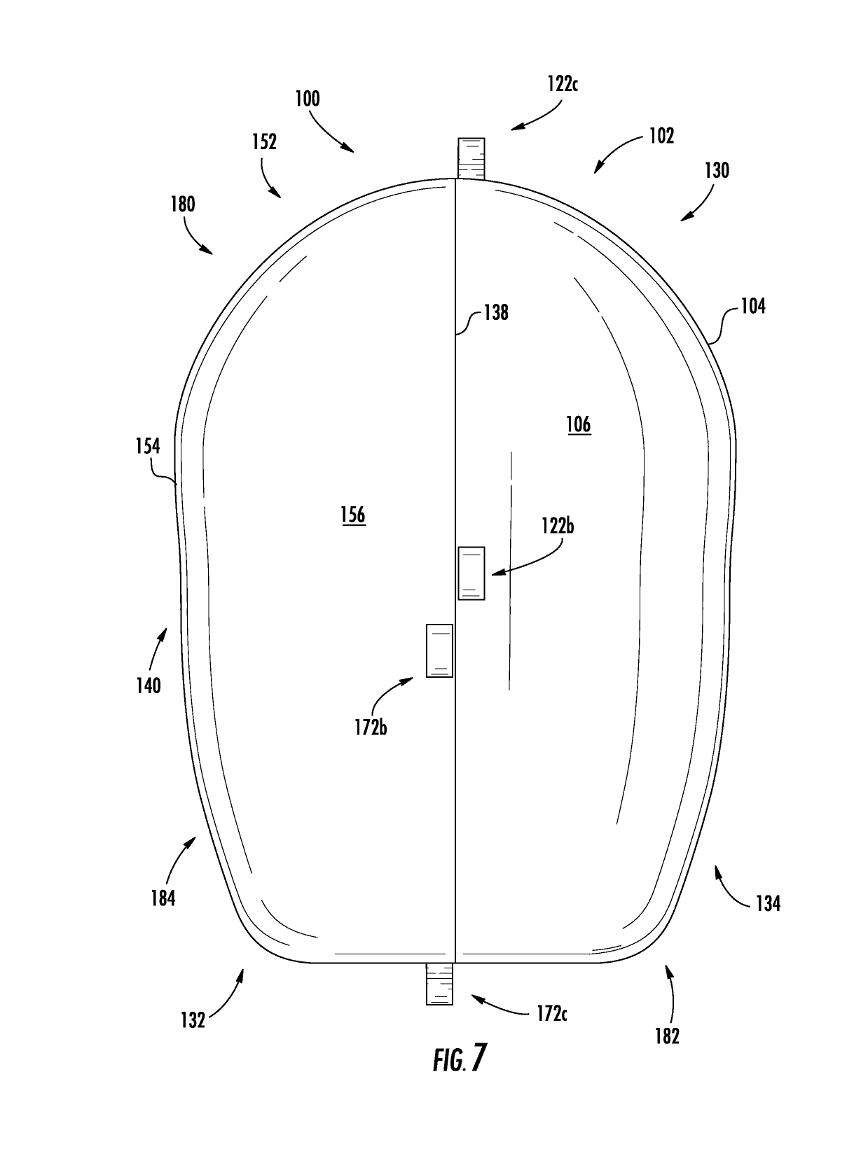

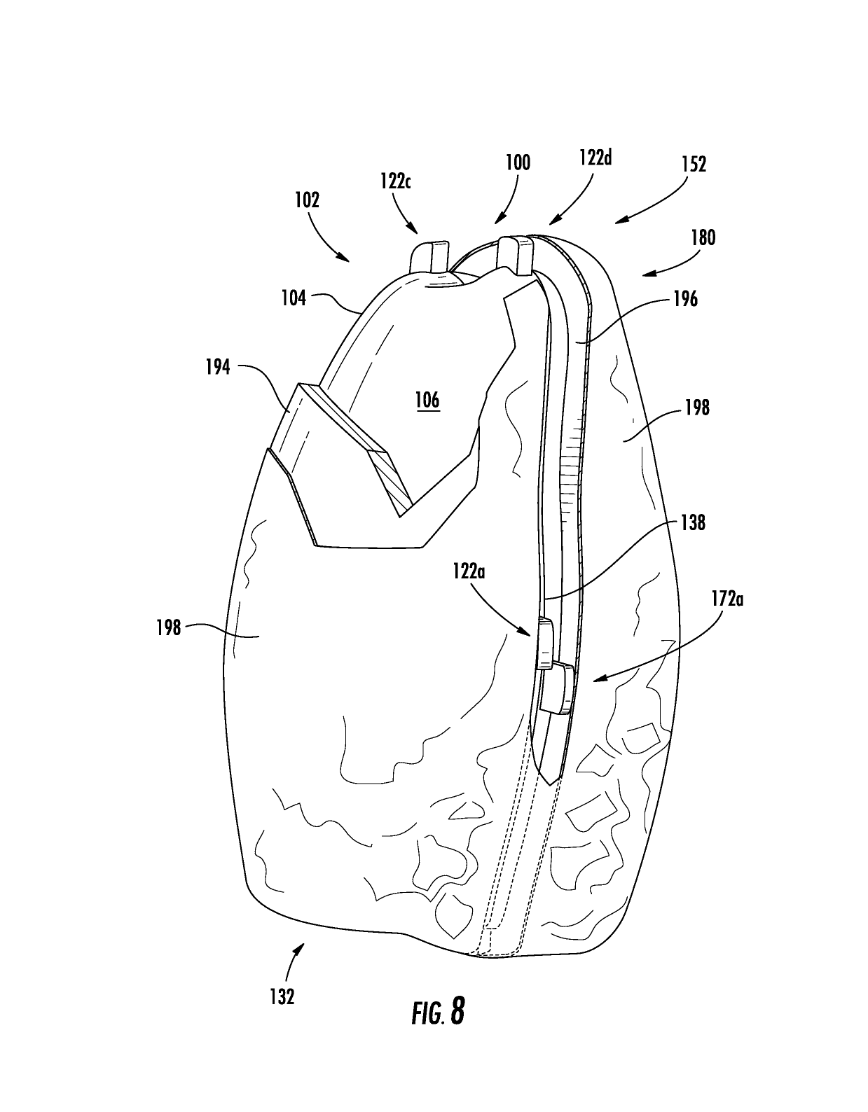

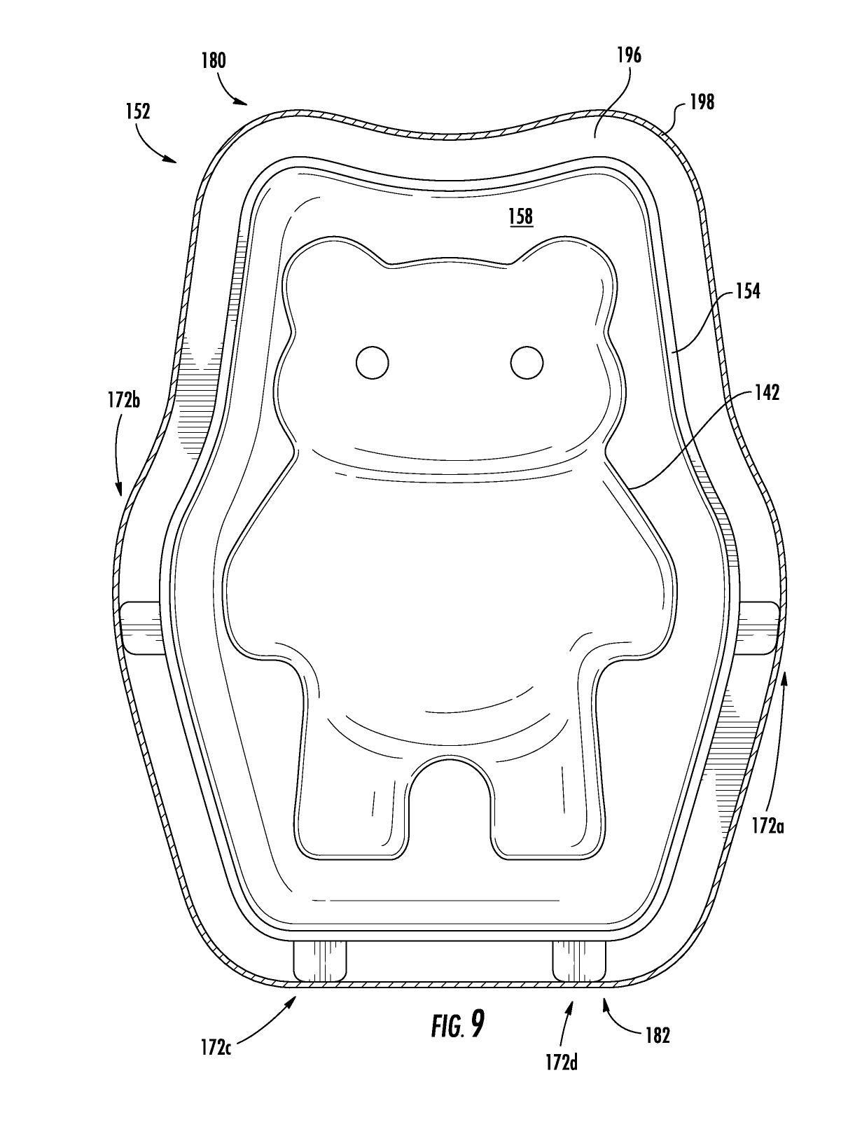

Referring to FIGS. 1-9, an embodiment of a capsule 100 having a longitudinal axis 144 greater than a transverse axis 148 is shown and described. The capsule 100 includes a first half 102 and a second half 152 that are joined longitudinally to form a resealable divisible container with a hollow interior. In an embodiment, the first half 102 receives a first confectionary coating 194, and the second half 152 receives a second confectionary coating 196. The confectionary coating includes chocolate. The coatings 194 and 196 may be enclosed by an outer covering 198 protecting the confectionary coating until it is consumed. The covering 198 may be manufactured from plastic or metal foil, including aluminum foil.

The first half 102 includes a body 104 with an exterior surface 106 and an interior surface 108. The body 104 forms a top end 130, a bottom end 132, a left side 134, and a right side 136. The body 104 terminates at a rim 109 at the periphery of the body 104 defining an opening 110 into an interior. A flange 112 at the rim 109 includes an engagement member 113. The second half 152 includes a body 154 with an exterior surface 156 and an interior surface 158. The body 154 forms a top end 180, and bottom end 182, a left side 184, and a right side 186. The body terminates at a rim 159 at the periphery of the body 104 defining an opening 160 into an interior. A flange 162 at the rim 159 includes an engagement member 163 that compliments engagement member 113. The first half 102 and second half 152 are joined at the openings 110, 160 forming a joint 138 in the divisible container. The joint 138 is aligned along a longitudinal plane extending between the left side 134 and right side 136 of the capsule 100. The capsule 100 has a midsection 140 that has a transverse cross sectional width between the left side 134 and right side 136 greater than the cross sectional width at the top end 180 and bottom end 132.

In an embodiment, engagement member 113 is one or more ridges 116 formed by an outer surface 114 of the flange 112 opposite an inner surface 118 of the flange 112, and engagement member 163 is one or more grooves 168 formed by an inner surface 166 of the flange 162 opposite an outer surface 164 of the flange 162. In an embodiment, engagement member 113 is one or more grooves extending into the outer surface 114 of the flange 112 opposite an inner surface 118 of the flange 112, and engagement member 163 is one or more ridges extending from the inner surface 166 of the flange 162 opposite an outer surface 164 of the flange 162.

The first and second halves 102, 152 include one or more projections integrally formed with the respective body providing an indication to a user that an object is beneath a confectionary coating 194, 196, and providing structure for a user to engage to facilitate separation of halves 102 and 152. The projection may be one or more of various structural arrangements including rectangular, tubular, teardrop, spherical, or any other suitable geometrical configuration, etc.

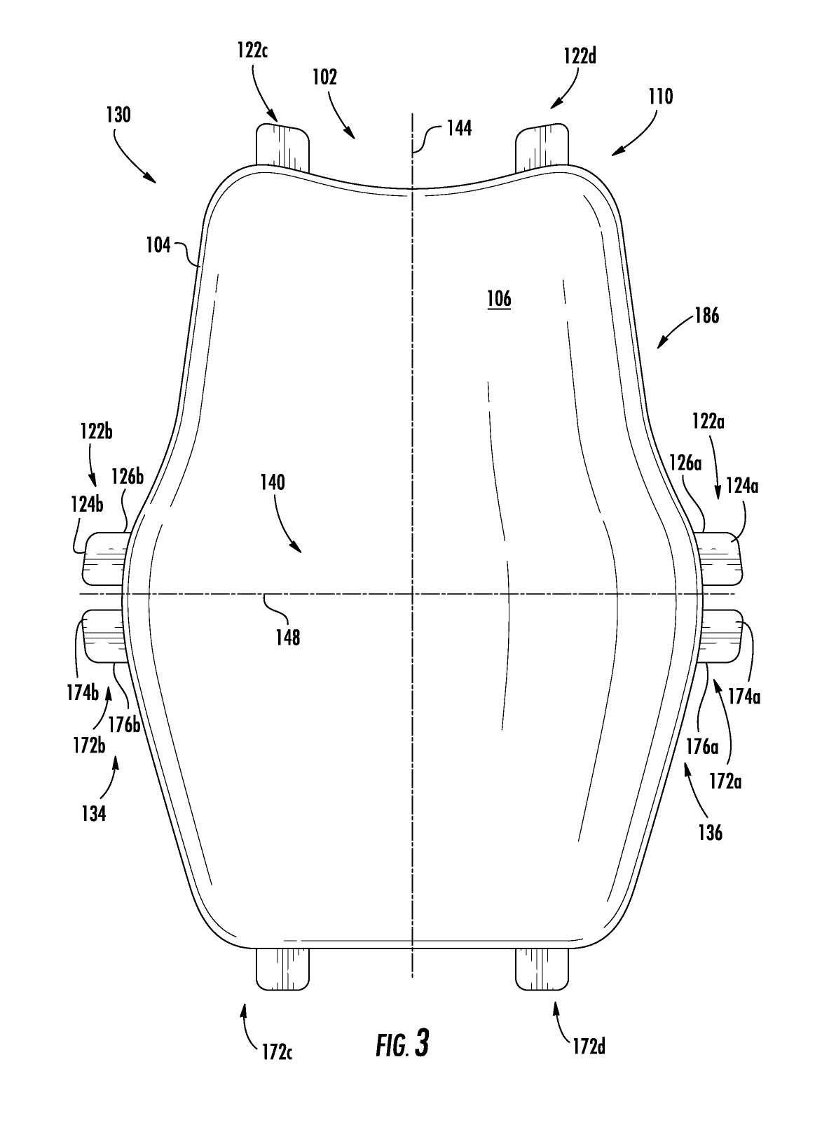

Referring to FIG. 3, an embodiment of a generally rectangular projection, projection 122, is shown adjacent the flange 112 adjacent the midsection 140 on the right side 136 of the first half 102. The projection 122a includes a side portion 126a extending from the exterior surface 106 terminating at an upper portion 124a. The projection 122a has a rectangular cross-section with a longitudinal cross-section generally parallel to the flange 112. In an embodiment, the upper portion 124a is angled generally parallel with the underlying surface 106. Projection 172a is adjacent the rim 159 adjacent the midsection 140 on the second half 152. An embodiment of a generally rectangular projection, projection 172, is shown adjacent flange 162 adjacent the midsection 140 on the right side 186 of the second half 152. The projection 172a includes a side portion 176a extending from the exterior surface 156 terminating at an upper portion 174a. The projection 172a has a rectangular cross-section with a longitudinal cross-section generally parallel to the flange 162. In an embodiment, an outer edge of the upper portion 174a is angled generally parallel with the underlying surface 156. In FIGS. 3-7, projections 122a, 172a are shown offset from one another when the first half 102 and second half 152 are joined at the openings 110, 160. Advantageously, projection 172a allows a user to bias projection 172a away from the first half 102, disengaging engagement member 163 from engagement member 113 along the right end 136, thereby facilitating separation of halves 102, 152, and access to the object 142 in the hollow interior. Further, the projections 122a, 172a, not being a continuous, circumferential structure extending around the rims of the halves does not add to the stiffness or rigidity of the body halves thereby allowing the engagement members to move away and separate from one another.

An embodiment of the capsule 100 includes a plurality of projections 122, 172. Referring to FIG. 3, the first half 102 includes projection 122a, and projection 122b. Projection 122b is adjacent the flange 112 adjacent the midsection 140 on the left side 134, and widely spaced from projection 122a on the right side 136. The projection 122b includes a side portion 126b extending from the exterior surface 106, terminating at an upper portion 124b. The second half 152 includes projection 172a and projection 172b. Projection 172b is adjacent the rim 159 adjacent the midsection 140 on the left side 184, and widely spaced from projection 172a on the right side 186. The projection 172b includes a side portion 176b extending from the exterior surface 156, terminating at an upper portion 174b. In FIGS. 3-7, projections 122b, 172b are shown offset from one another when the first half 102 and second half 152 are joined at the openings 110, 160. Similar to above, projection 172b allows a user to bias projection 172b away from the first half 102, disengaging engagement member 163 from engagement member 113 along the left side 134, thereby facilitating separation of the halves 102, 152, and access to the object in the hollow interior.

Referring to FIG. 3, the first half 102 includes additional projections 122c and 122d adjacent the flange 112 at the top end 130, and the second half 152 includes additional projections 172c and 172d adjacent the rim 159 at the bottom end 182. Projections 172c and 172d advantageously allow a user to bias the projections away from the first half 102, disengaging engagement member 163 along the bottom end 182 from engagement member 113 along the bottom end 132.

Projection 122c is widely spaced from projection 122d, and projections 122a, 122b, 122c, and 122d are widely spaced with respect to each other. Projection 172c is widely spaced from projection 172d, and projections 172a, 172b, 172c, and 172d are widely spaced with respect to each other.

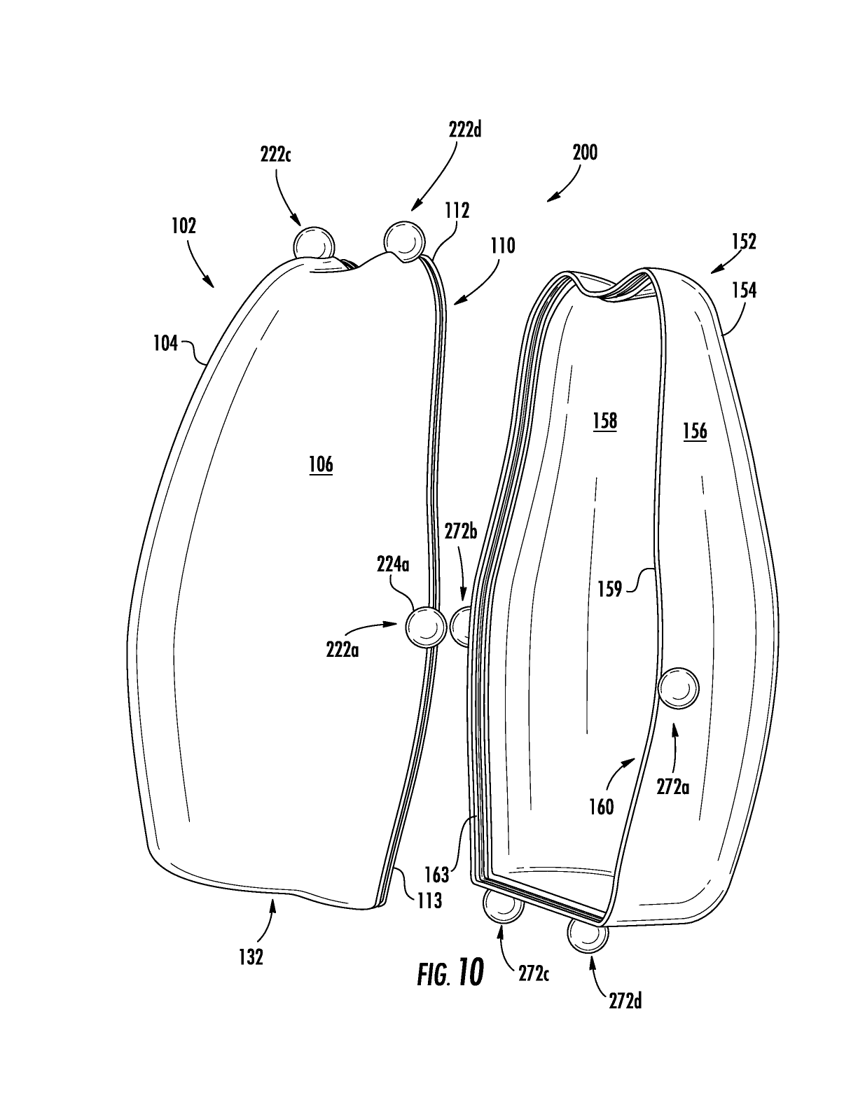

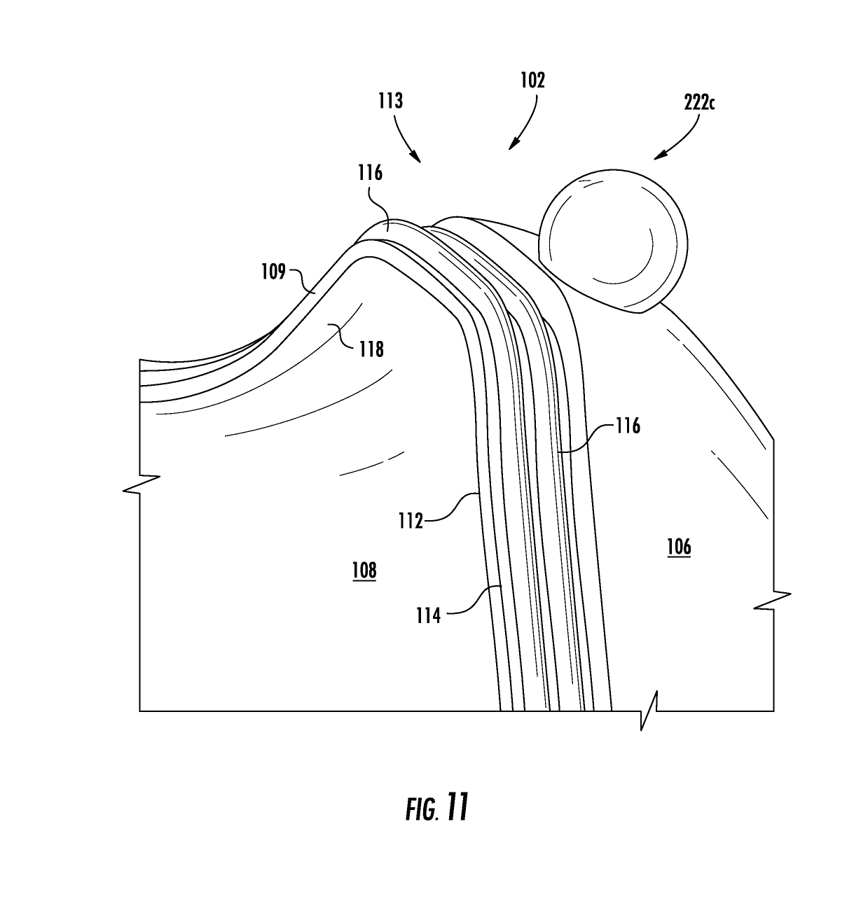

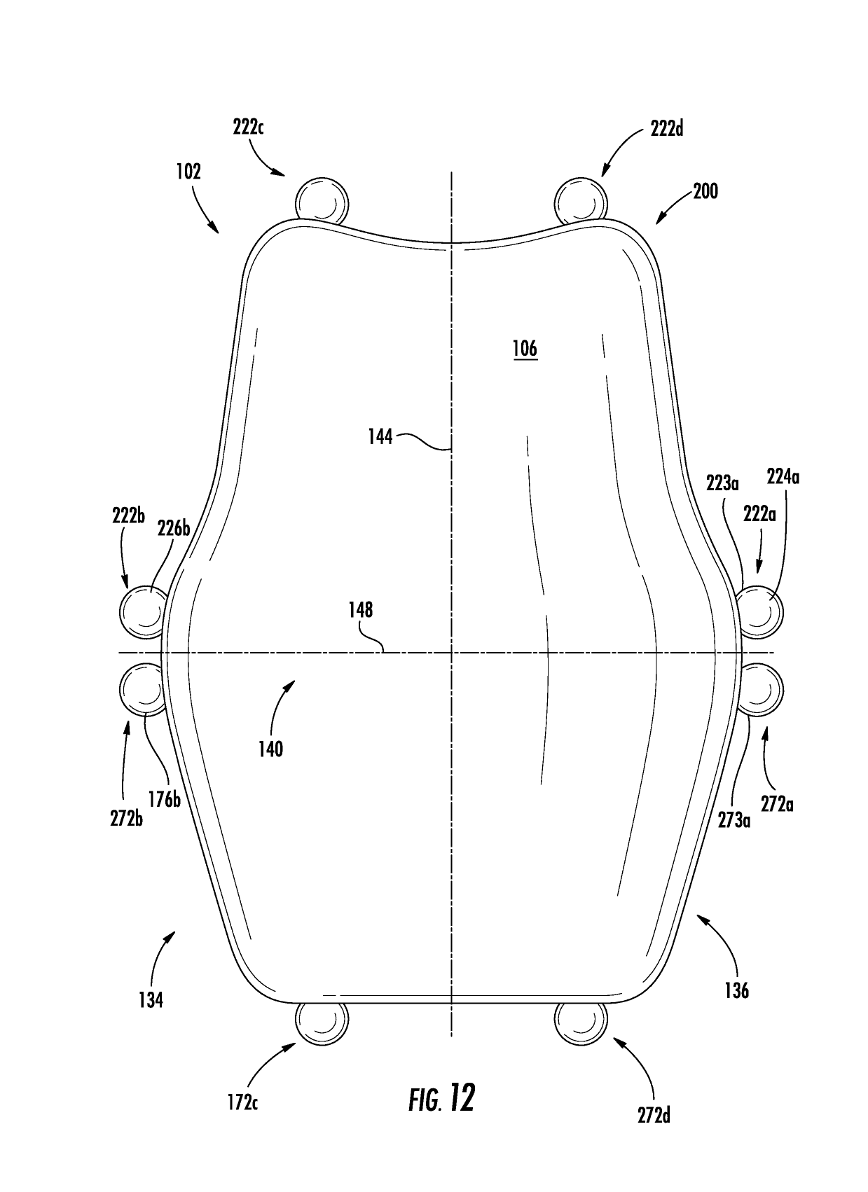

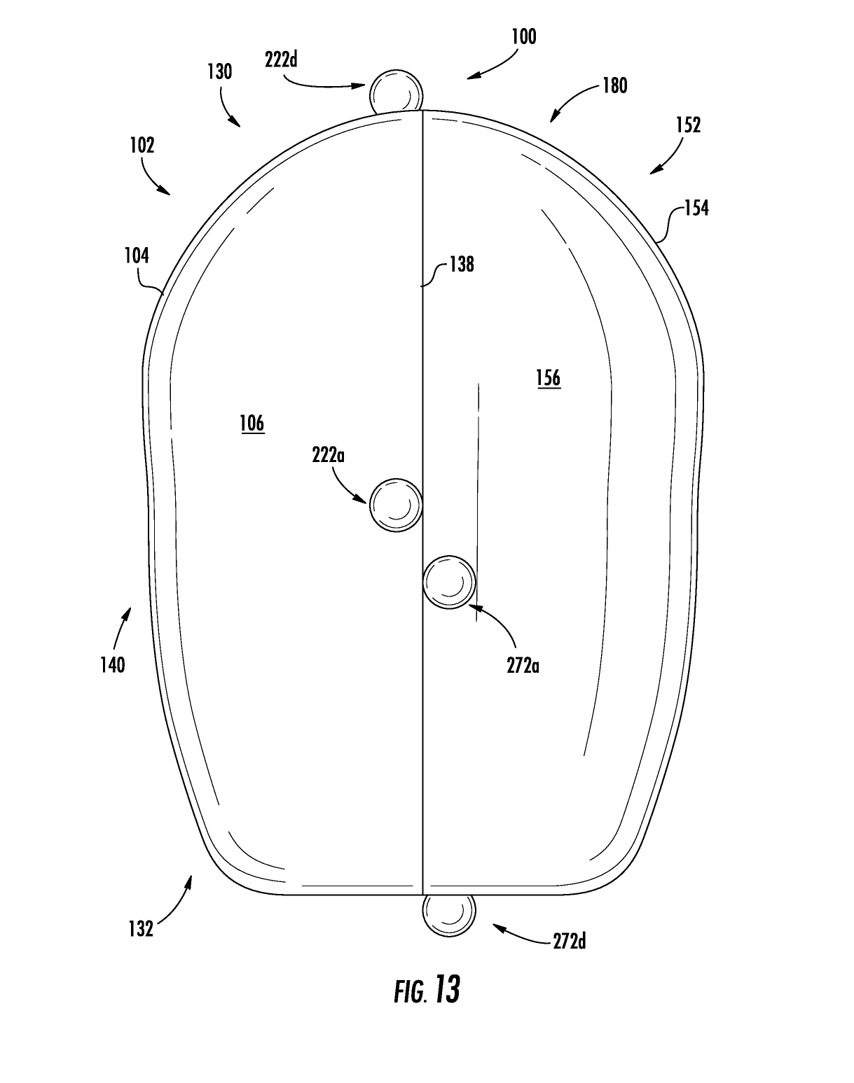

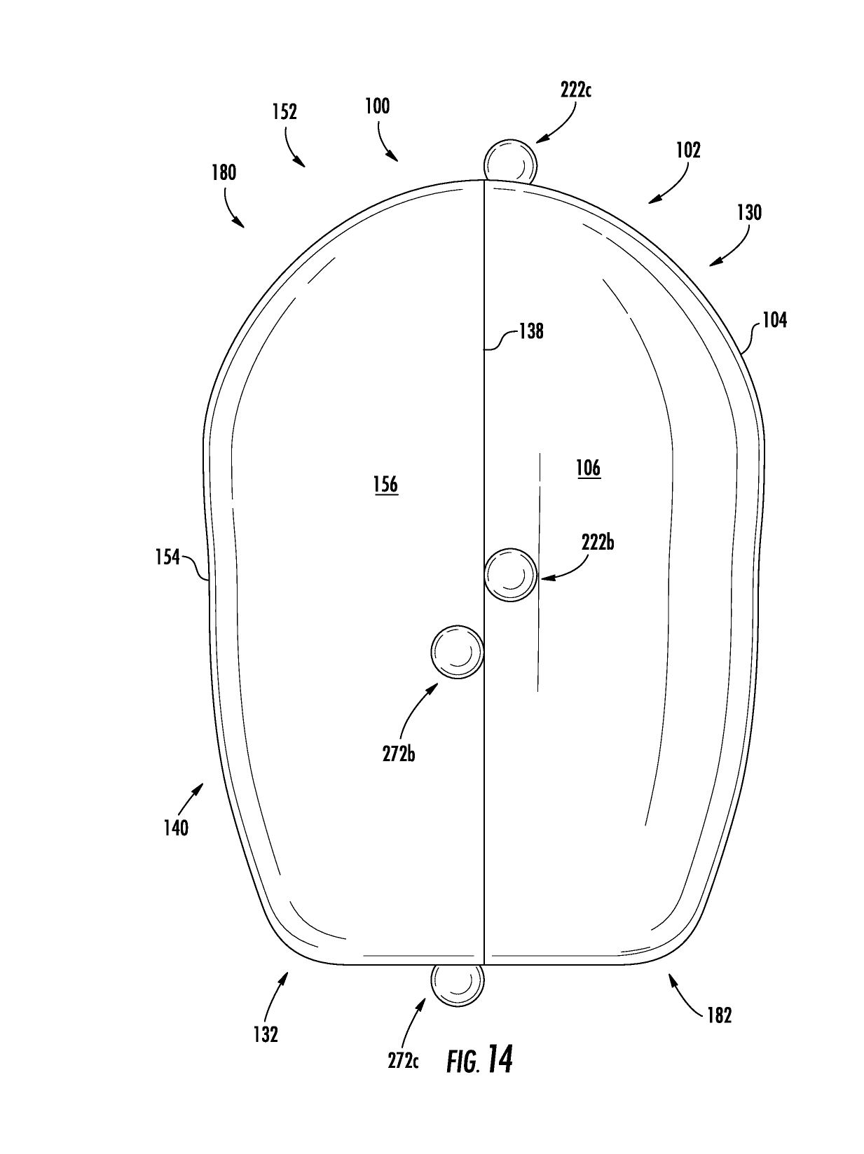

Referring to FIGS. 10-14, an embodiment of a capsule 200 having a longitudinal axis 144 greater than a transverse axis 148 is shown with the first and second halves 102, 152 including one or more spherical projections 222, 272 formed by the respective body providing an indication to a user that an object is beneath a confectionary coating 194, 196 and providing structure for a user to engage to facilitate separation of halves 102 and 152. Projection 222a, is shown adjacent the flange 112 adjacent the midsection 140 on the right side 136 of the first half 102. Projection 222a includes a side portion 226a extending from a base 223a at the exterior surface 106, terminating at a dome-shaped upper portion 224a. The projection 222a has a circular cross-section. Projection 272a is adjacent the rim 159 adjacent the midsection 140 on the second half 152. Projection 272a includes a side portion 276a extending from a base 273 at the exterior surface 156, terminating at a dome-shaped upper portion 274a. The projection 272a has a circular cross-section. In FIGS. 12-14, projections 222a, 272a are shown offset and spaced from one another when the first half 102 and second half 152 are joined at the openings 110, 160. Advantageously, projection 272a allows a user to bias projection 272a away from the first half 102, disengaging engagement member 163 from engagement member 113 along the right side 136, thereby facilitating separation of halves 102, 152, and access to the object in the hollow interior.

The first half 102 includes an additional projection 222b adjacent the flange 112 adjacent the midsection 140 on the left side 134 widely spaced from projection 222a on the right side 136, and projections 222c and 222d adjacent the flange 112 at the top end 130. The second half 152 includes an additional projection 272b adjacent the rim 159 adjacent the midsection 140 on the left side 184, and widely spaced from projection 272a on the right side 186, and projections 272c and 272d adjacent the rim 159 at the bottom end 182. Projections 272b, 272c, and 272d advantageously allow a user to bias the projections away from the first half 102, disengaging engagement member 163 from engagement member 113, facilitating separation of the first and second halves 102, 152.

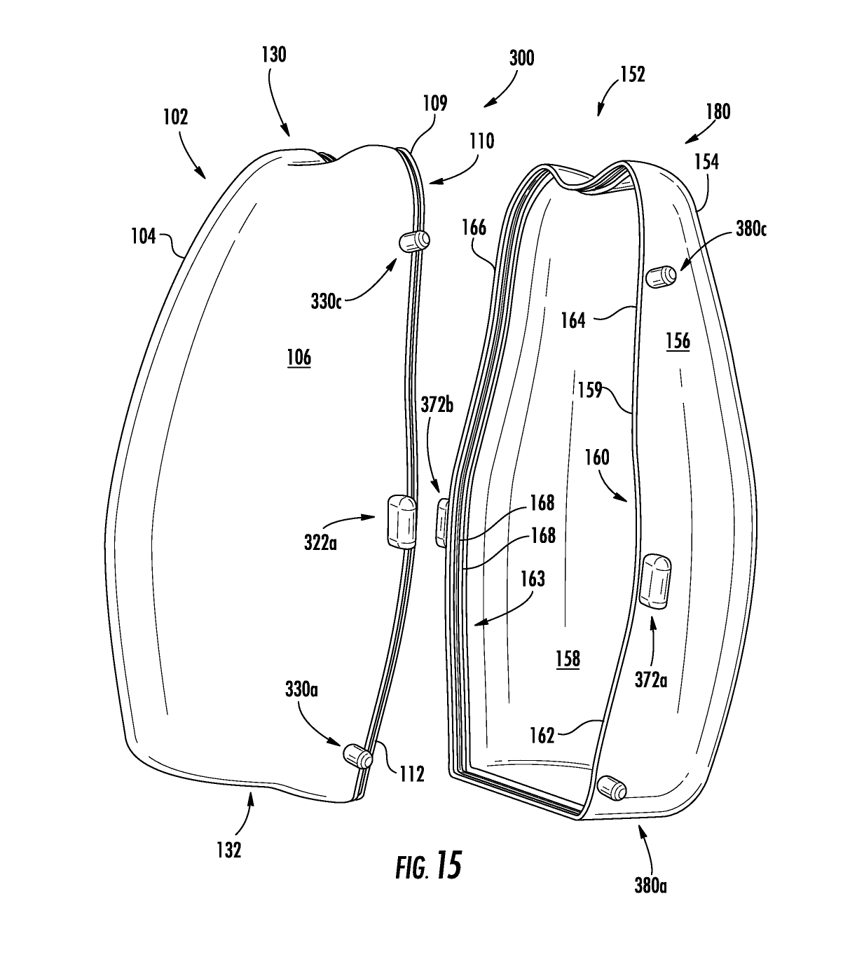

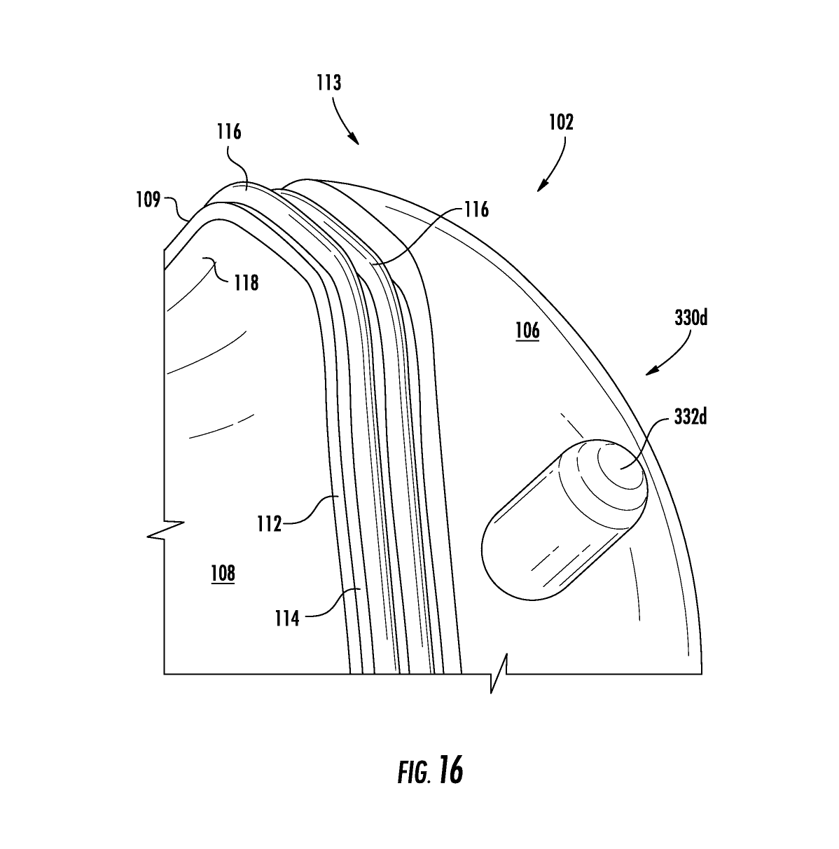

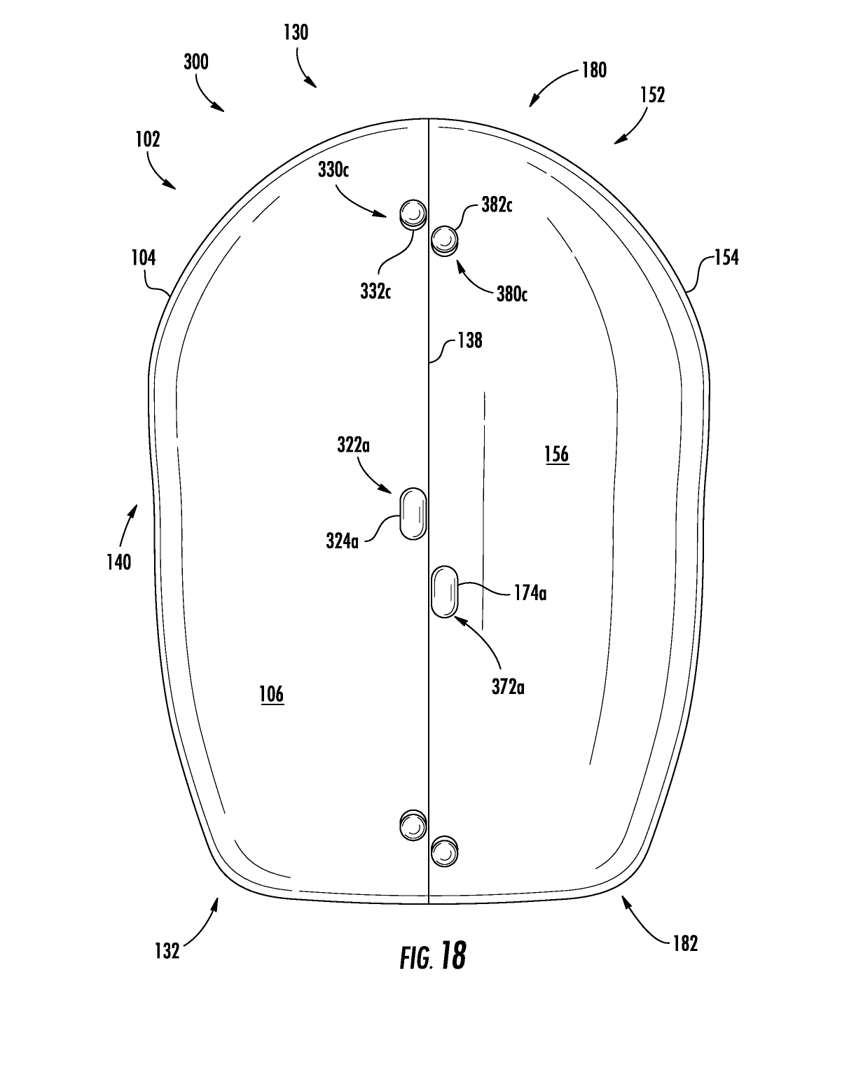

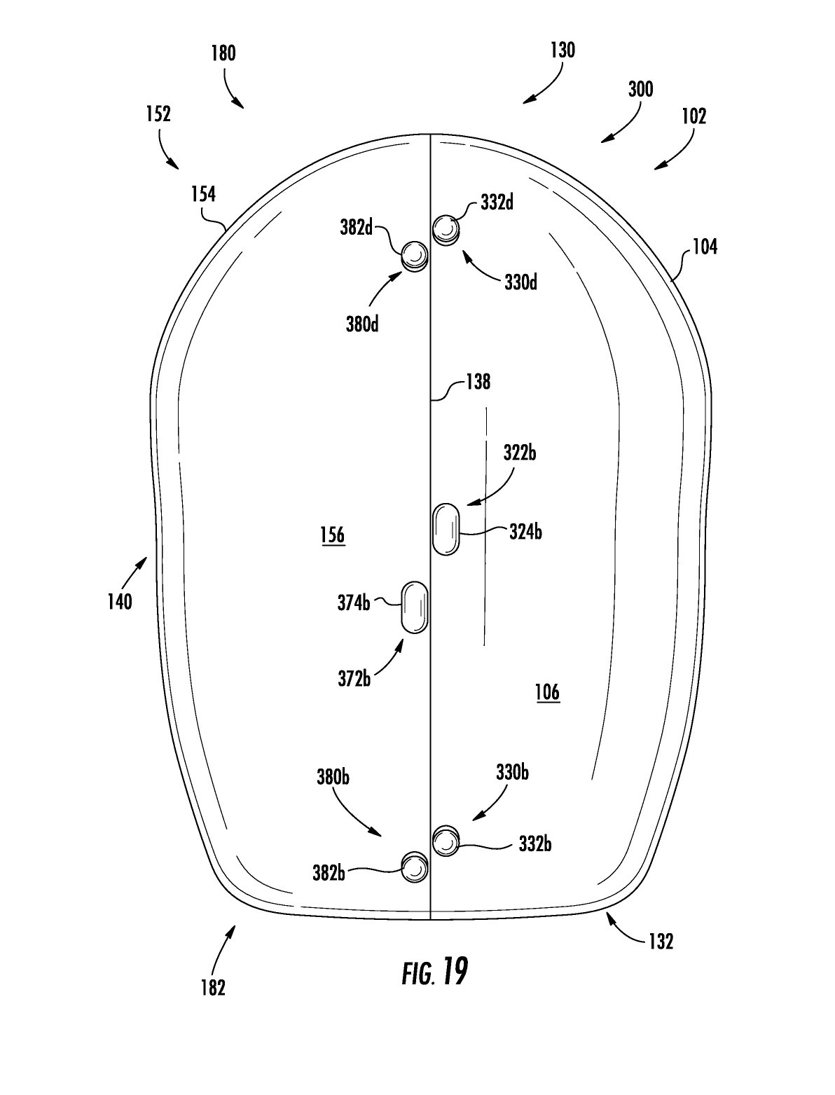

Referring to FIGS. 15-19, an embodiment of a capsule 300 having a longitudinal axis 144 greater than a transverse axis 148 is shown with first and second halves 102, 152 including a combination of rectangular projections 322, 372 and tubular projections 330, 380 formed by the respective body halves providing an indication to a user that an object is beneath a confectionary coating 194, 196 and providing structure for a user to engage to facilitate separation of halves 102 and 152.

In an embodiment, projections 322 and 330 are located adjacent flange 112, and projections 372 and 380 are located adjacent flange 162.

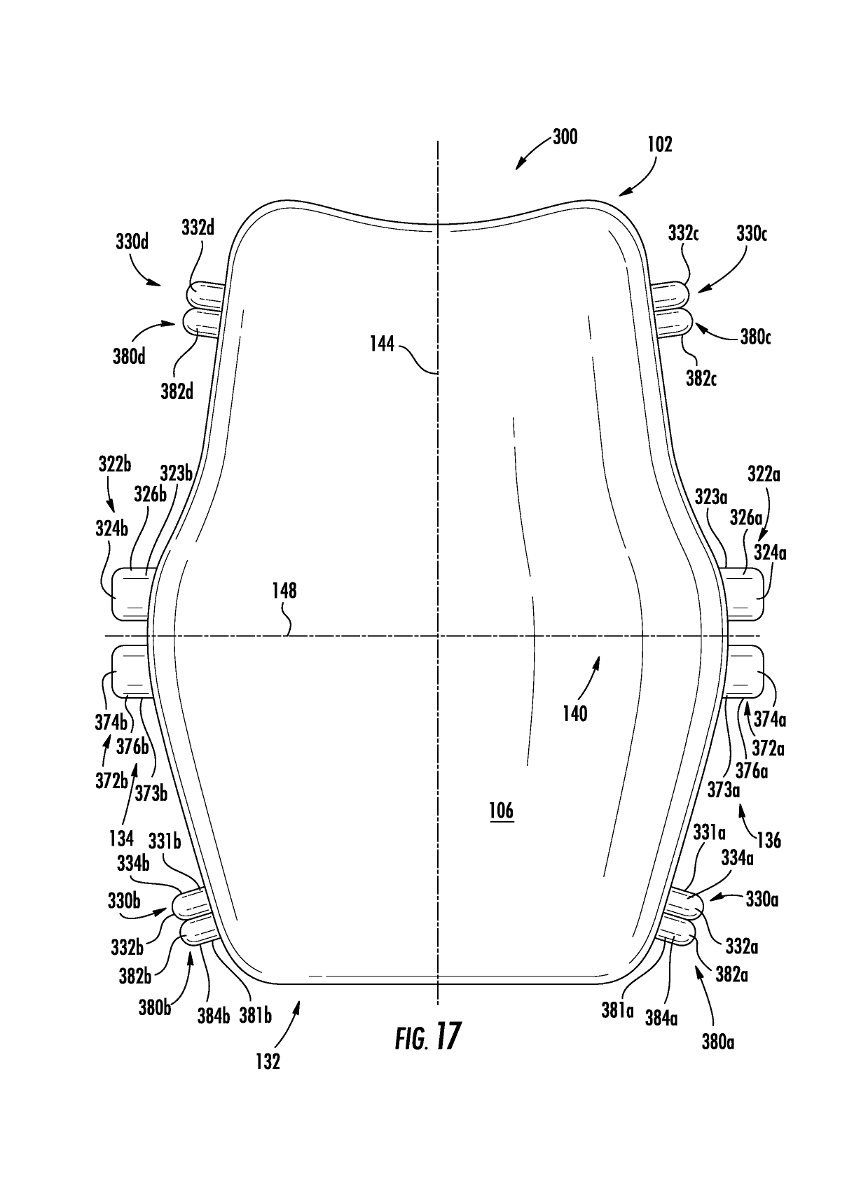

Projection 322a is adjacent the midsection 140 on the right side 136 of the first half 102, and includes a side portion 326a extending from a base 323a at the exterior surface 106, terminating at an upper portion 324a. Projection 322a has a rectangular cross-section. Projection 322b is adjacent the midsection 140 on the left side 134 of the first half 102, and includes a side portion 326b extending from a base 323b at the exterior surface 106, terminating at an upper portion 324b. Projection 322b has a rectangular cross-section. Projection 372a is adjacent the midsection 140 on the right side 186 of the second half 152, and includes a side portion 376a extending from a base 373a at the exterior surface 156, terminating at an upper portion 374a. Projection 372a has a rectangular cross-section. Projection 372b is adjacent the midsection 140 on the left side 184 of the second half 152, and includes a side portion 376b extending from a base 373b at the exterior surface 156, terminating at an upper portion 374b. Projection 372b has a rectangular cross-section. In an embodiment, upper portion 324a, 324b, 374a, and 374b have curved corners eliminating sharp edges that might puncture a covering. In FIGS. 17-19, projections 322a and 372a are shown offset and spaced from one another when the first half 102 and second half 152 are joined at the openings 110, 160. Advantageously, projection 372a allows a user to bias projection 372a away from the first half 102, disengaging engagement member 163 from engagement member 113 along the right side 136, thereby facilitating separation of halves 102, 152, and access to the object in the hollow interior. In addition, projections 322b and 372b are shown offset and spaced from one another when the first half 102 and second half 152 are joined at the openings 110, 160. Advantageously, projection 372b allows a user to bias projection 372b away from the first half 102, disengaging engagement member 163 from engagement member 113 along the left end 134, thereby facilitating separation of halves 102, 152, and access to the object in the hollow interior. Projection 322a is widely spaced from projection 322b, and projection 372a is widely spaced from projection 372b. Projection 330a is adjacent the bottom end 132 on the right side of the first half 102, and includes a side portion 334a extending from a base 331a at the exterior surface 106, terminating at a dome-shaped upper portion 332a. Projection 330a has a circular cross-section. Projection 330b is adjacent the bottom end 132 on the left side of the first half 102, and includes a side portion 334b extending from a base 331b at the exterior surface 106, terminating at a dome-shaped upper portion 332b. Projection 330b has a circular cross-section, and is widely spaced from projection 330b. Projection 330c is adjacent the top end 130 on the right side of the first half 102, and includes a side portion extending from a base at the exterior surface 106, terminating at a dome-shaped upper portion 332c. Projection 330c has a circular cross-section. Projection 330d is adjacent the top end 130 on the left side of the first half 102, and includes a side portion extending from a base at the exterior surface 106, terminating at a dome-shaped upper portion 332d. Projection 330d has a circular cross-section. Projections 330a, 330b, 330c, and 330d are widely spaced as to each other. Projection 380a is adjacent the bottom end 182 on the right side of the second half 152, and includes a side portion 384a extending from a base 381a at the exterior surface 156, terminating at a dome-shaped upper portion 382a. Projection 380a has a circular cross-section. Projection 380b is adjacent the bottom end 182 on the left side of the second half 152, and includes a side portion 384b extending from a base 381b at the exterior surface 156, terminating at a dome-shaped upper portion 382b. Projection 380b has a circular cross-section. Projection 380a is widely spaced from projection 380b. Projection 380c is adjacent the top end 180 on the right side of the second half 152, and includes a side portion extending from a base at the exterior surface 156, terminating at a dome-shaped upper portion 382c. Projection 380c has a circular cross-section. Projection 380d is adjacent the top end 180 on the left side of the second half 152, and includes a side portion extending from a base at the exterior surface 156, terminating at a dome-shaped upper portion 382d. Projection 380d has a circular cross-section. Projections 380a, 380b, 380c, and 380d are widely spaced as to each other.

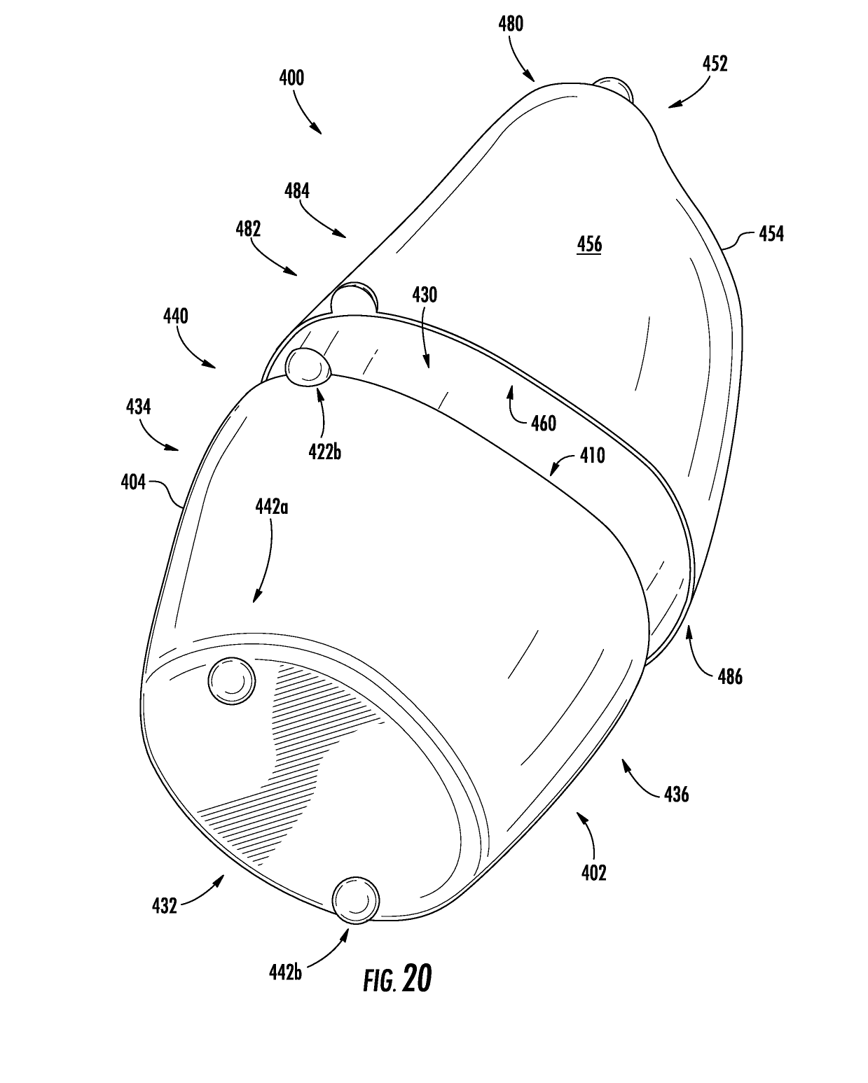

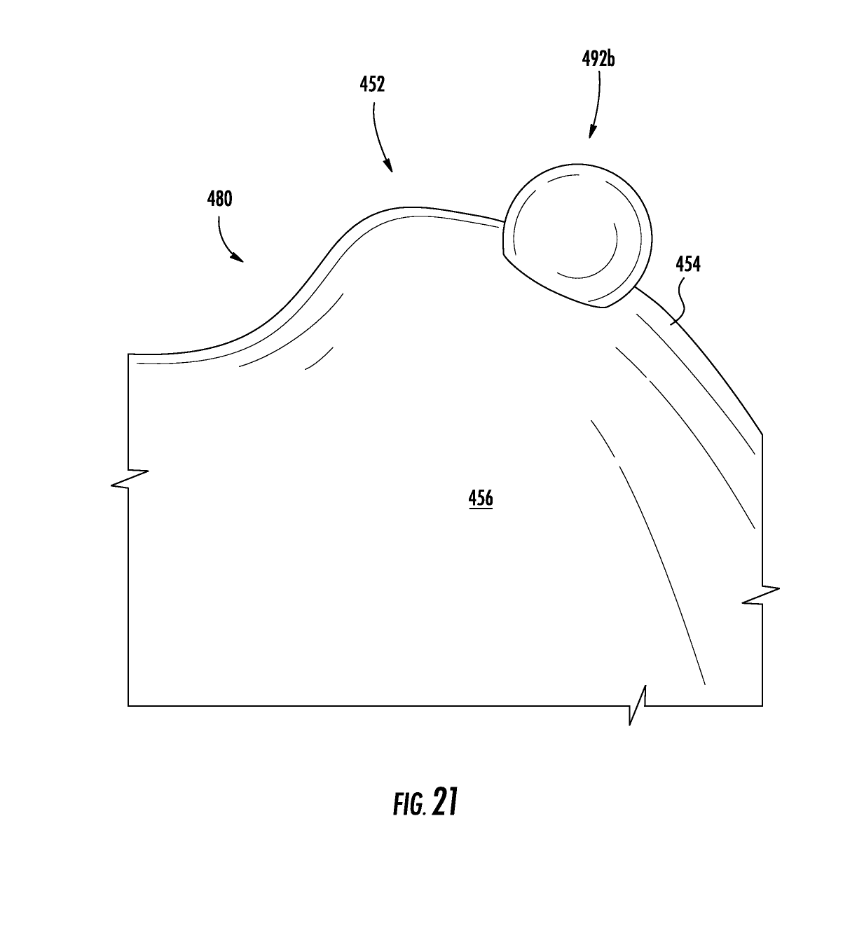

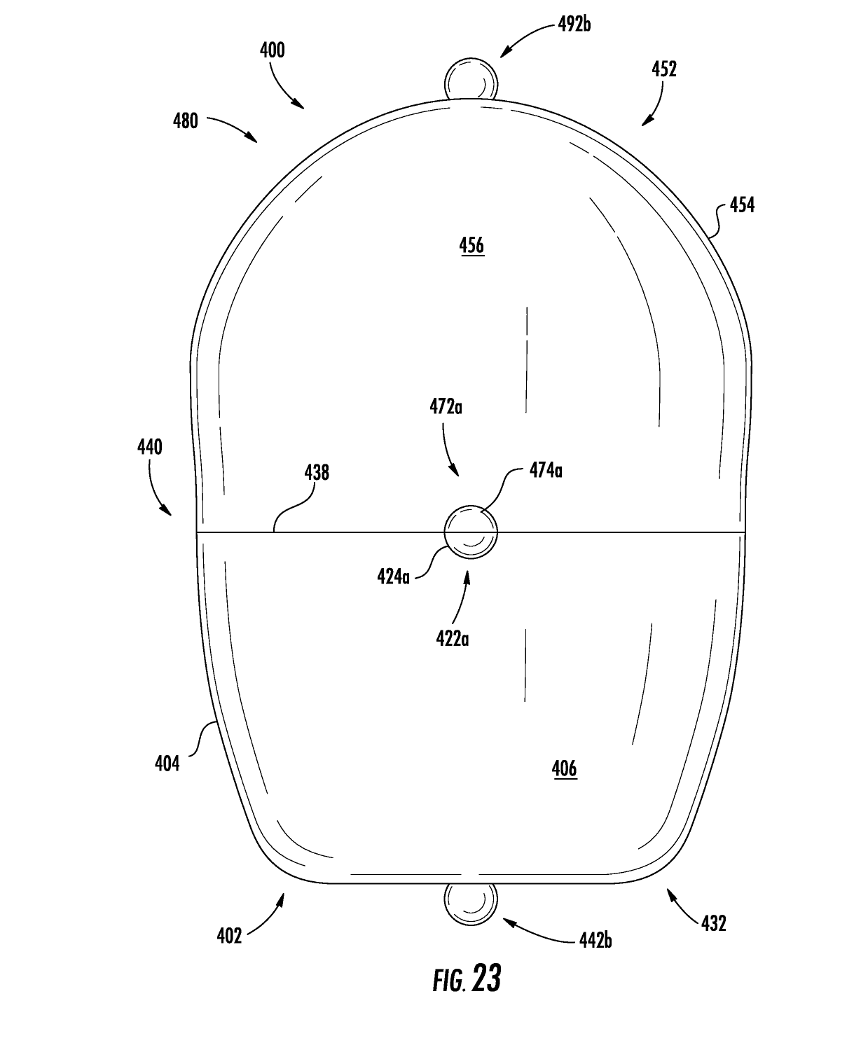

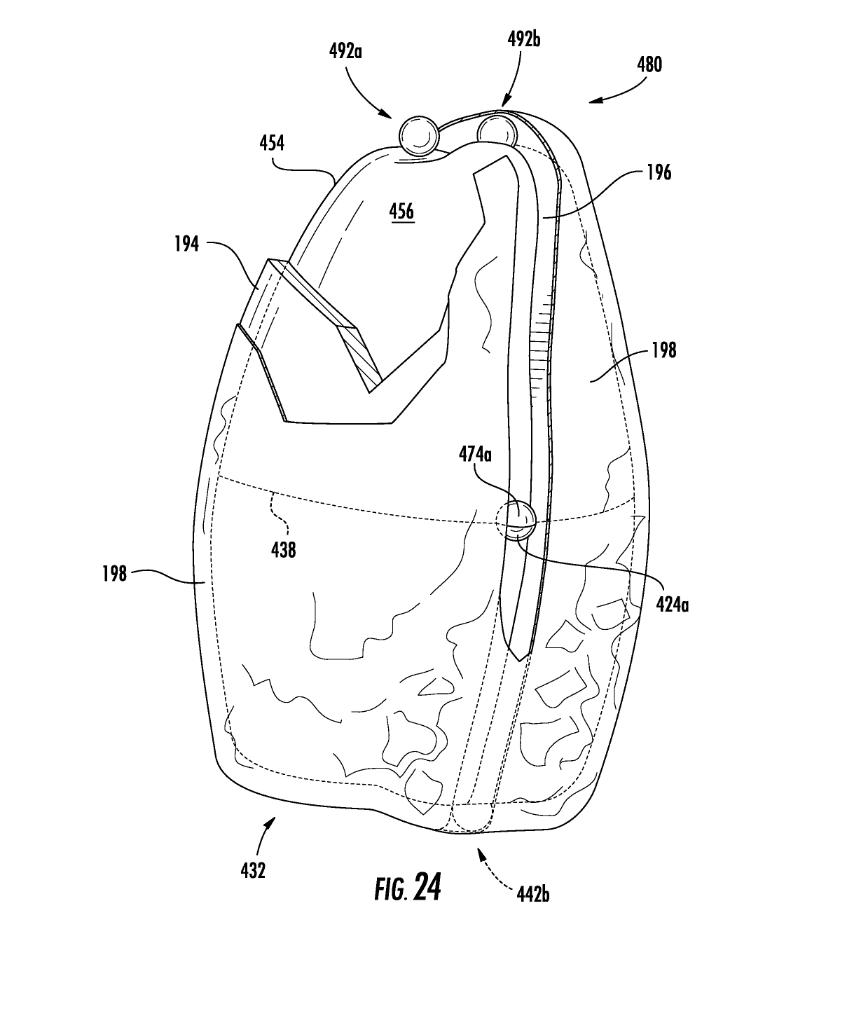

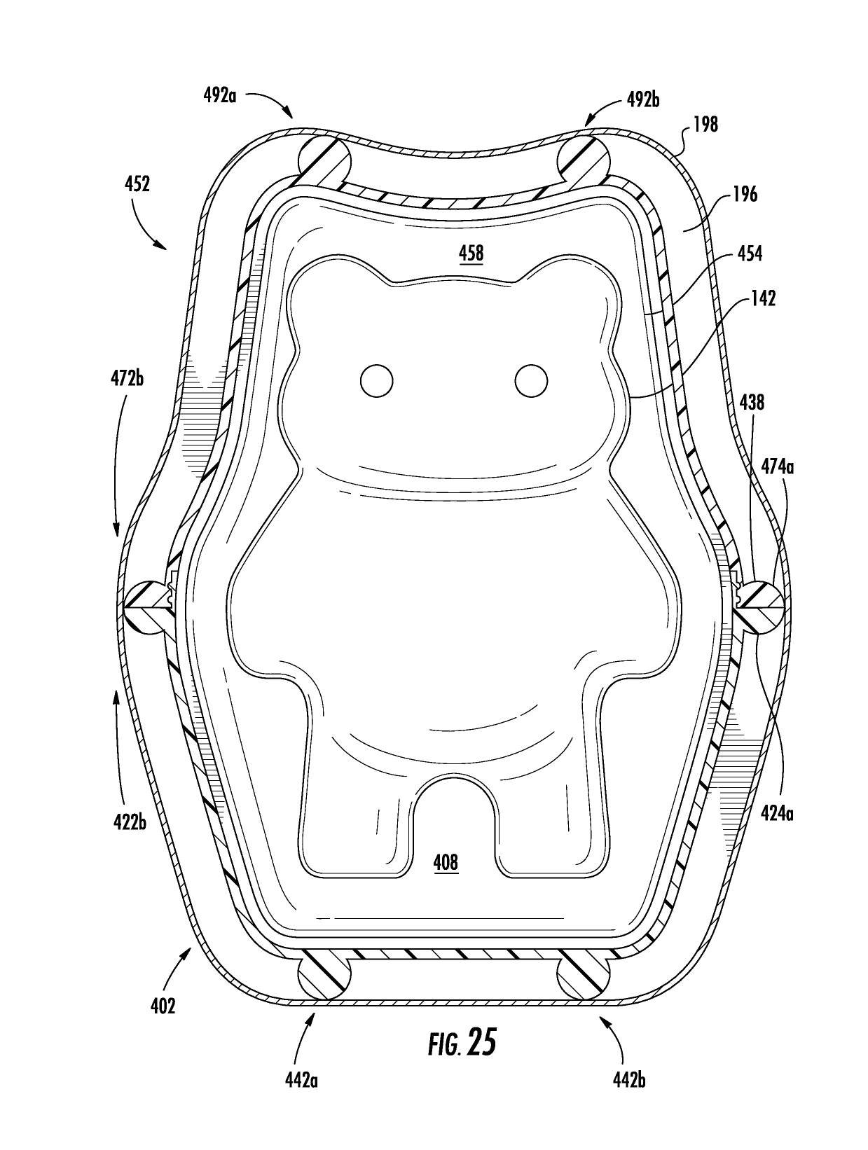

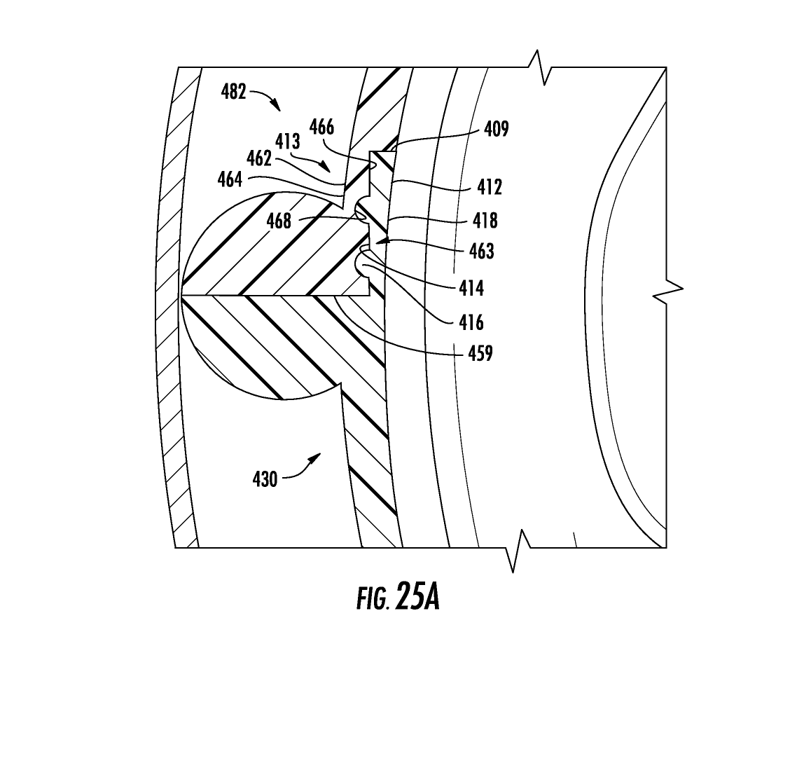

Referring to FIGS. 20-25, a capsule 400 having a longitudinal axis 444 greater than a transverse axis 448 includes a first half 402 and a second half 452 joined about a plane extending horizontally through the transverse axis 448 forming divisible resealable container. In an embodiment, a first confectionary coating 194 at the exterior of the container 400 is formed to and covers half of the first half 402 and half of the second half 452 forming an edge adjacent a plane extending longitudinally through the longitudinal axis 444 between the left side 434 and right side 436, and an opposite second confectionary coating 196 is formed to and covers half of the first half 402 and half of the second half 452 forming an edge opposite the first confectionary coating 194 edge. The coatings 194 and 196 may be enclosed by an outer covering 198.

The first half 402 includes a body 404 with an exterior surface 406 and an interior surface 408 forming an upwardly open container. The body 404 forms a top end 430, a bottom end 432, a left side 434, and a right side 436. The body 404 forms a rim 409 at the top end 430 defining an opening 410 into an interior. A flange 412 at the rim 409 includes an engagement member 413. The second half 452 includes a body 454 with an exterior surface 456 and an interior surface 458 forming a downwardly open container. The body 454 forms a top end 480, a bottom end 482, a left side 484, and a right side 486. The body 454 forms a rim 459 at the bottom end 482 defining an opening 460 into an interior. A flange 462 at the rim 459 includes an engagement member 463 that compliments engagement member 413. The first half 402 and second half 452 are joined at the openings 410, 460 forming a joint 438 in the divisible container. The capsule 400 has a midsection 440 that has a cross-sectional width between the left side 434 and right side 436 greater than the cross sectional width at the top end 480 and bottom end 432.

In an embodiment, engagement member 413 is one or more ridges 416 formed by an outer surface 414 of the flange 412 opposite an inner surface 418 of the flange 412, and engagement member 463 is one or more grooves 468 formed by an inner surface 466 of the flange 462 opposite an outer surface 464 of the flange 462. In an embodiment, engagement member 413 is one or more grooves extending into the outer surface 414 of the flange 412 opposite an inner surface 418 of the flange 412, and engagement member 463 is one or more ridges extending from the inner surface 466 of the flange 462 opposite an outer surface 464 of the flange 462.

The halves 402, 452 are separated by squeezing together opposite sides of the capsule 400 at the midsection 440 between the left side 434 and the right side 436.

The first and second halves 402, 452 include one or more widely spaced projections integrally formed with the respective body providing an indication to a user that an object is beneath the confectionary coatings 194, 196. In an embodiment, the first half 402 includes hemispherical projections 422 located at the midsection 440 adjacent the flange 412, and spherical projections 442 located adjacent the top end 430 and bottom end 432, and the second half 452 includes hemispherical projections 472 located at the midsection 440 adjacent the flange 462, and spherical projections 492 located adjacent the top end 430 and bottom end 432.

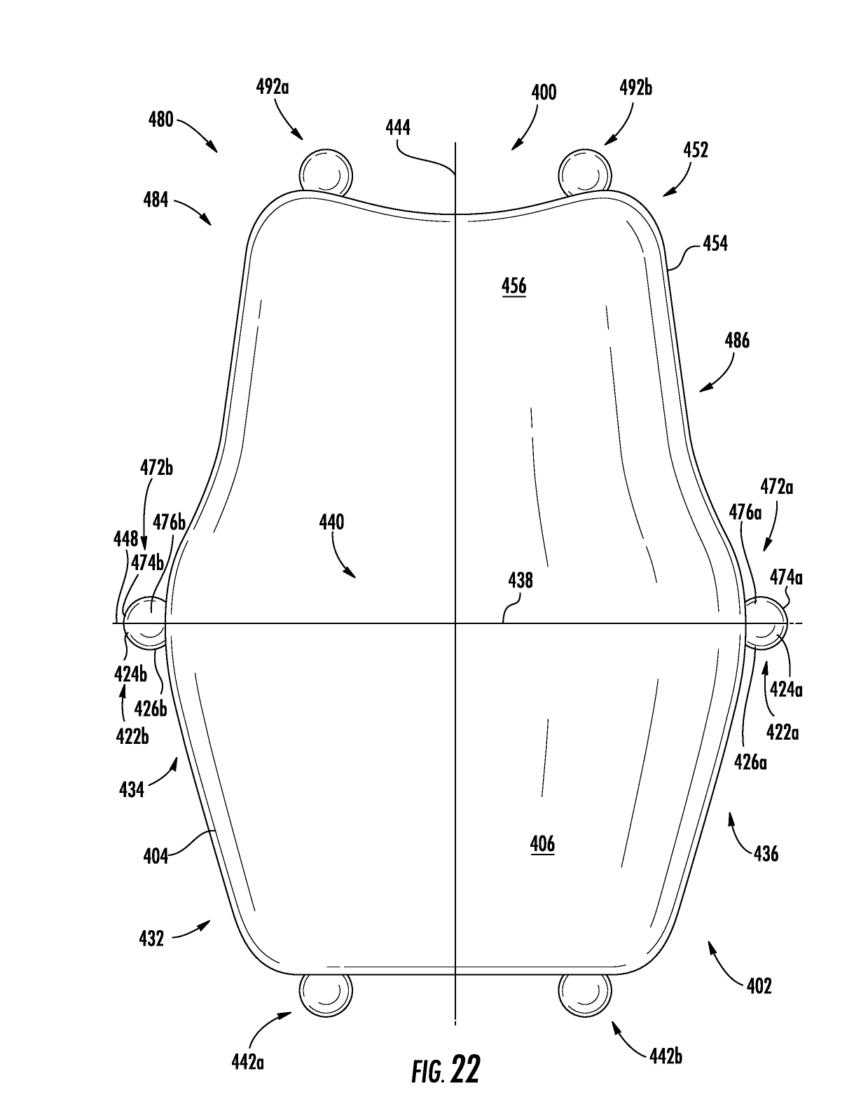

Referring to FIG. 22, hemispherical projection 422a is shown at the midsection 440 adjacent the flange 412 on the right side 436 of the first half 402. The projection 422a includes a side portion 426a extending from the exterior surface 406 terminating at an upper portion 424a. The lower half of the projection 422a is the curved portion of the hemisphere, and the upper half of the projection 422a is the generally planar portion of the hemisphere terminating adjacent the flange 412. Projection 422a has a hemispherical cross-section. Hemispherical projection 422b is shown at the midsection 440 adjacent the flange 412 on the left side 434 of the first half 402. The projection 422b includes a side portion 426b extending from the exterior surface 406 terminating at an upper portion 424b. The lower half of the projection 422b is the curved portion of the hemisphere, and the upper half of the projection 422b is the generally planar portion of the hemisphere terminating adjacent the flange 412. Projection 422b has a hemispherical cross-section.

Hemispherical projection 472a is shown at the midsection 440 adjacent the flange 462 on the right side 486 of the second half 452. The projection 472a includes a side portion 476a extending from the exterior surface 456 terminating at an upper portion 474a. The upper half of the projection 472a is the curved portion of the hemisphere, and the lower half of the projection 472a is the generally planar portion of the hemisphere terminating adjacent the flange 462. Projection 472a has a hemispherical cross-section. Hemispherical projection 472b is shown at the midsection 440 adjacent the flange 462 on the left side 484 of the second half 452. The projection 472b includes a side portion 476b extending from the exterior surface 456 terminating at an upper portion 474b. The upper half of the projection 472b is the curved portion of the hemisphere, and the lower half of the projection 472b is the generally planar portion of the hemisphere terminating adjacent the flange 462. Projection 472b has a hemispherical cross-section. In FIG. 22, the first half 402 is joined with second half 452 at the openings 410, 460 wherein the planar portion of projection 422a faces the planar portion of projection 472a, and the planar portion of projection 422b faces the planar portion of projection 472b.

The first half 402 includes spherical projections 442a and 442b at the bottom end 432 similar in location to projections 172c and 172d, and the second half 452 includes spherical projections 492a and 492b at the top end 480 similar in location to projections 122c and 122d.

Projections 422a, 422b, 442a, and 442b are widely spaced with respect to each other, and projections 472a, 472b, 492a, and 492b are widely spaced with respect to each other.

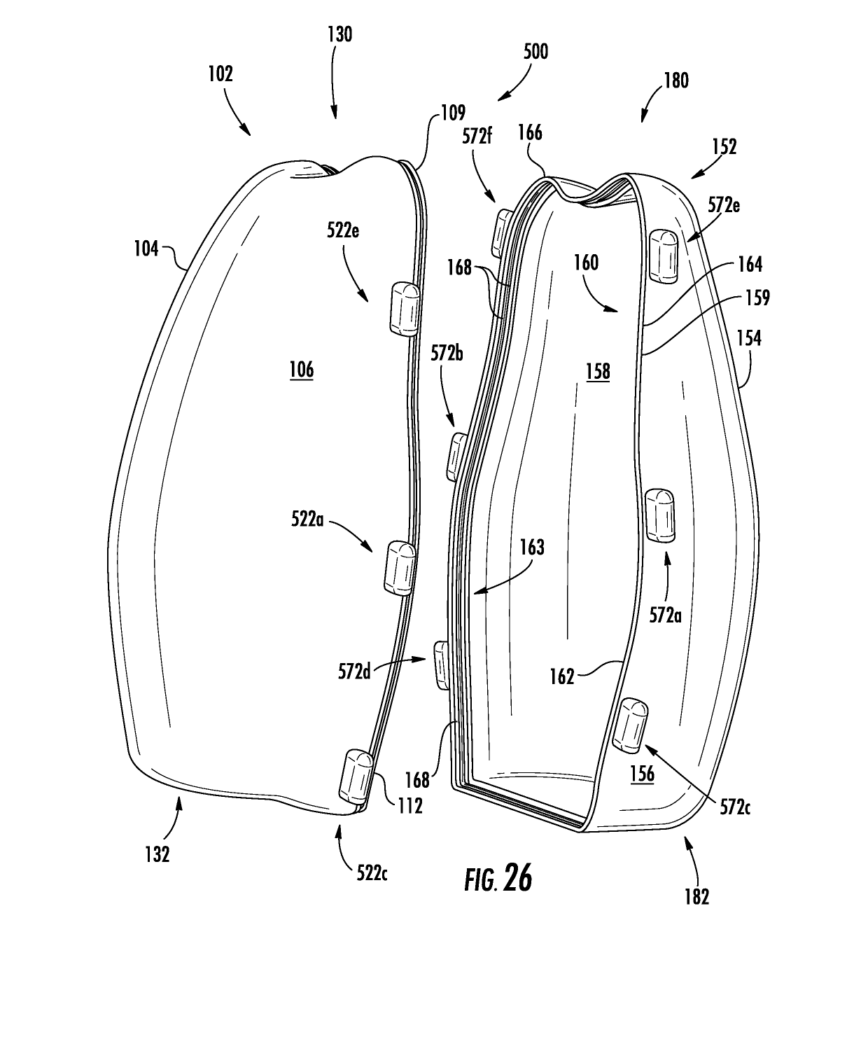

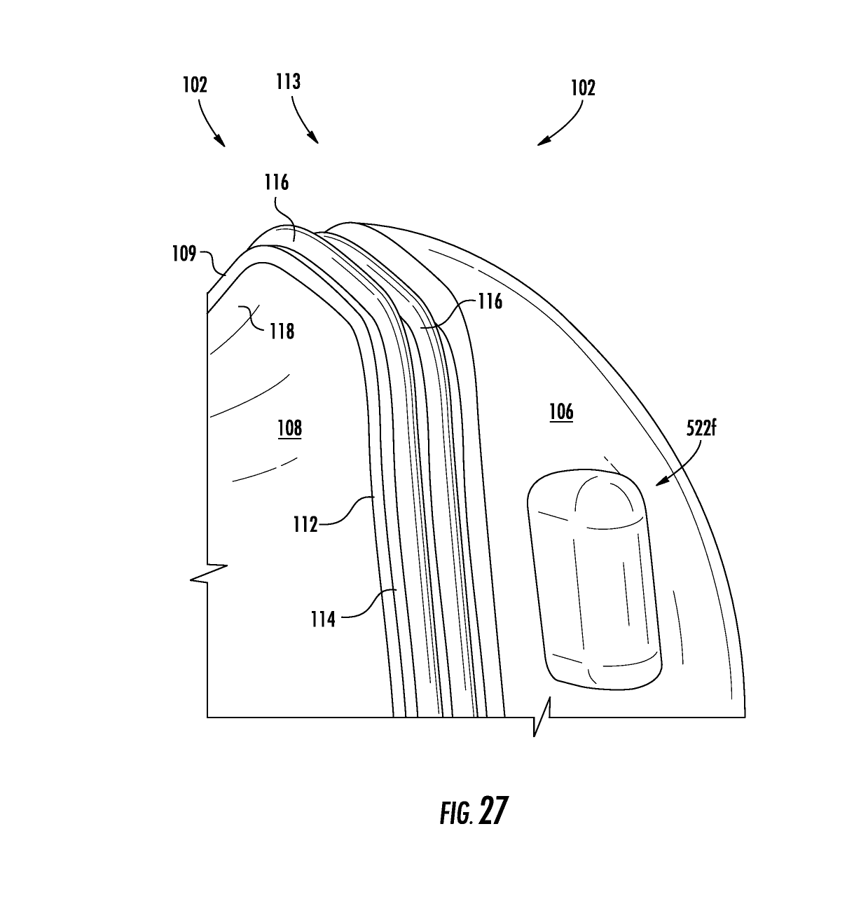

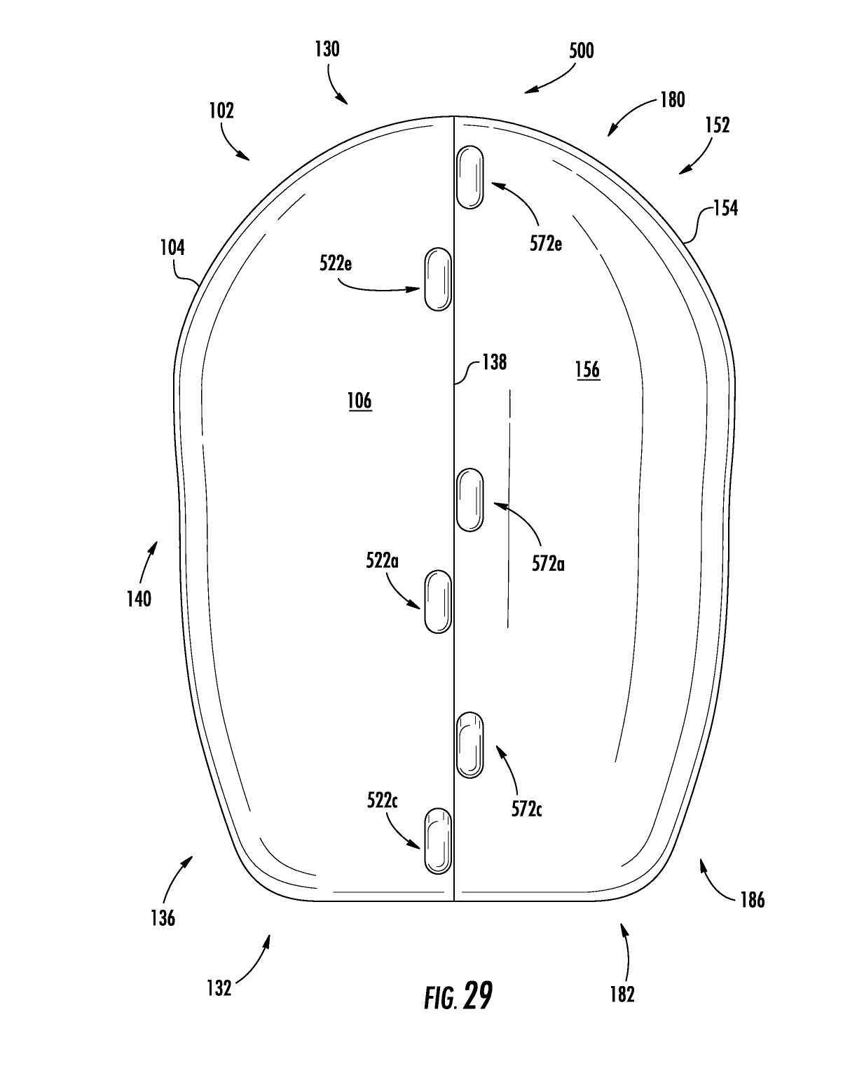

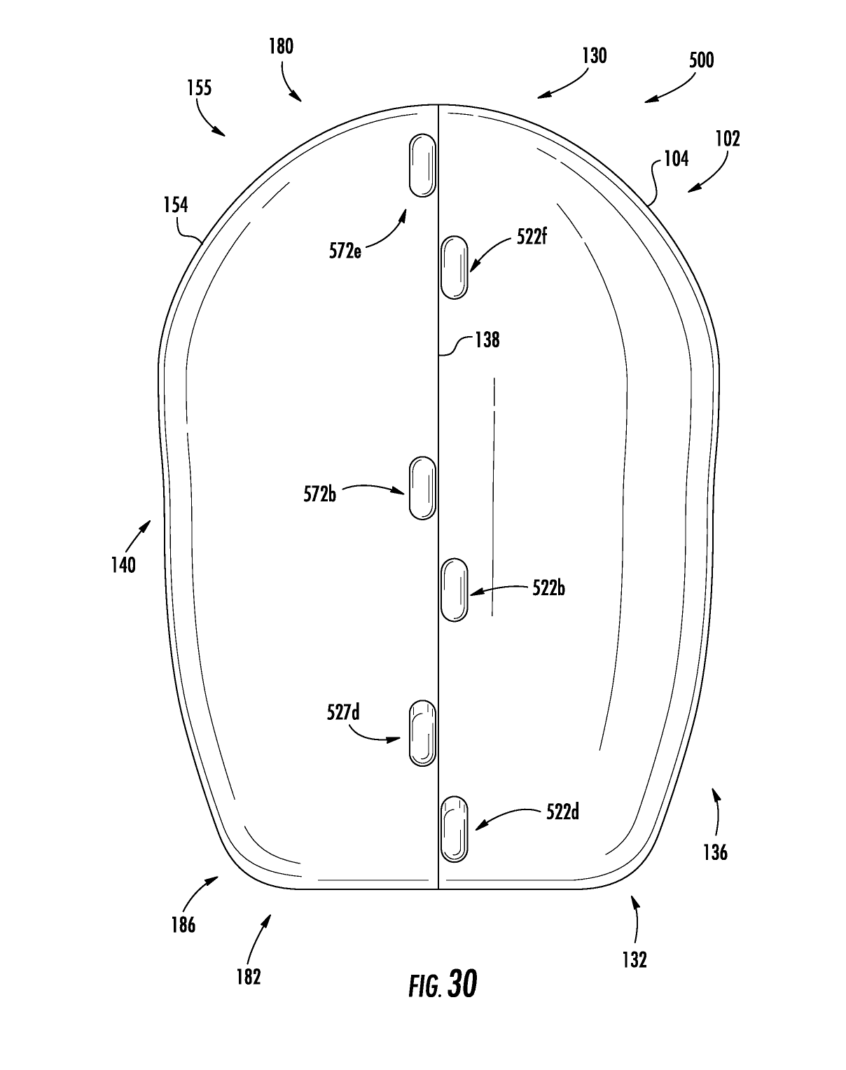

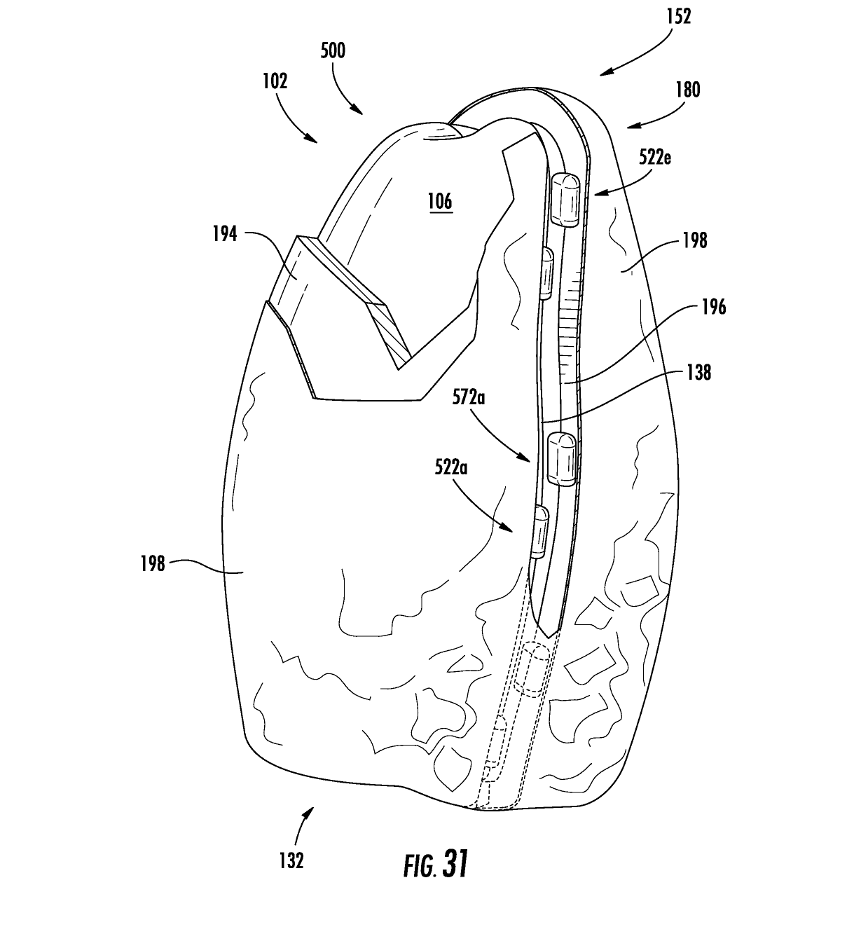

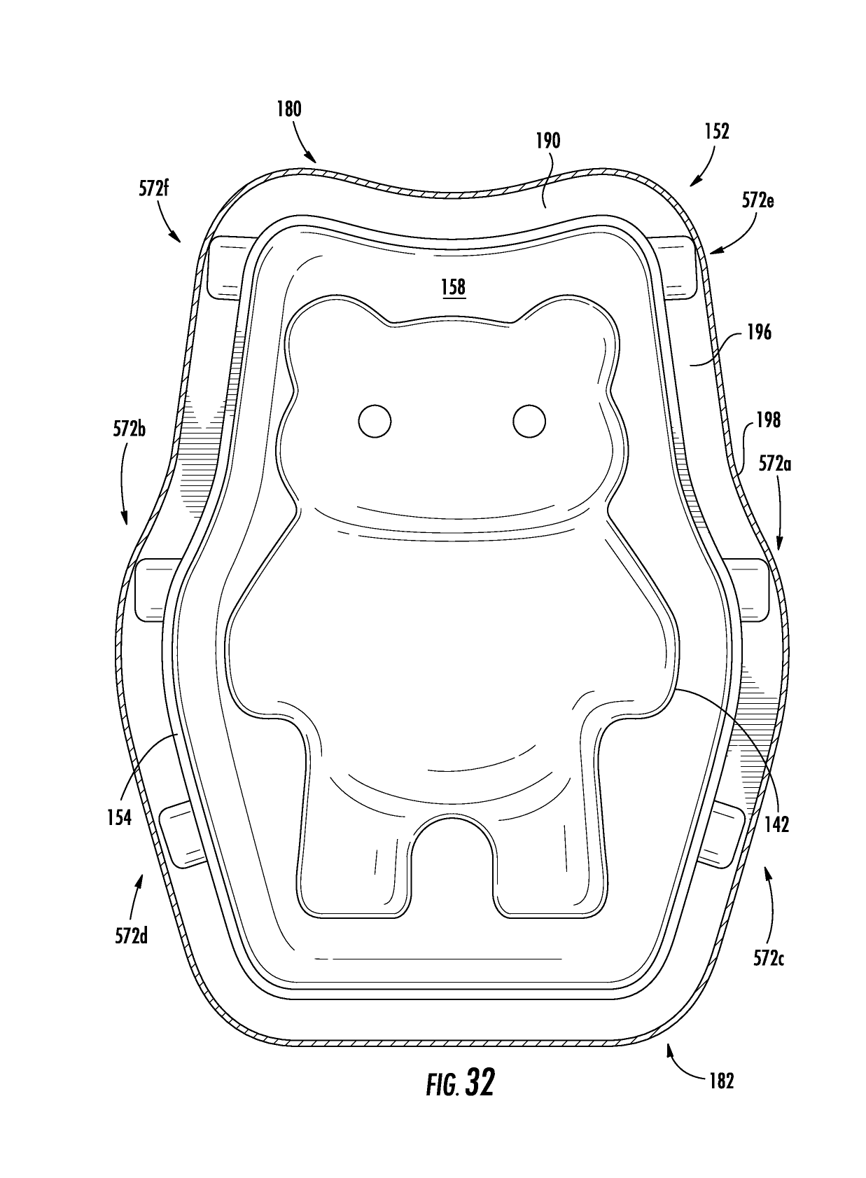

Referring to FIGS. 26-32, an embodiment of a capsule 500 having a longitudinal axis 144 greater than a transverse axis 148 is shown with first and second halves 102, 152 including a plurality of rectangular projections 522, 572 formed by the respective body halves providing an indication to a user that an object is beneath a confectionary coating 194, 196 and providing structure for a user to engage to facilitate separation of halves 102 and 152.

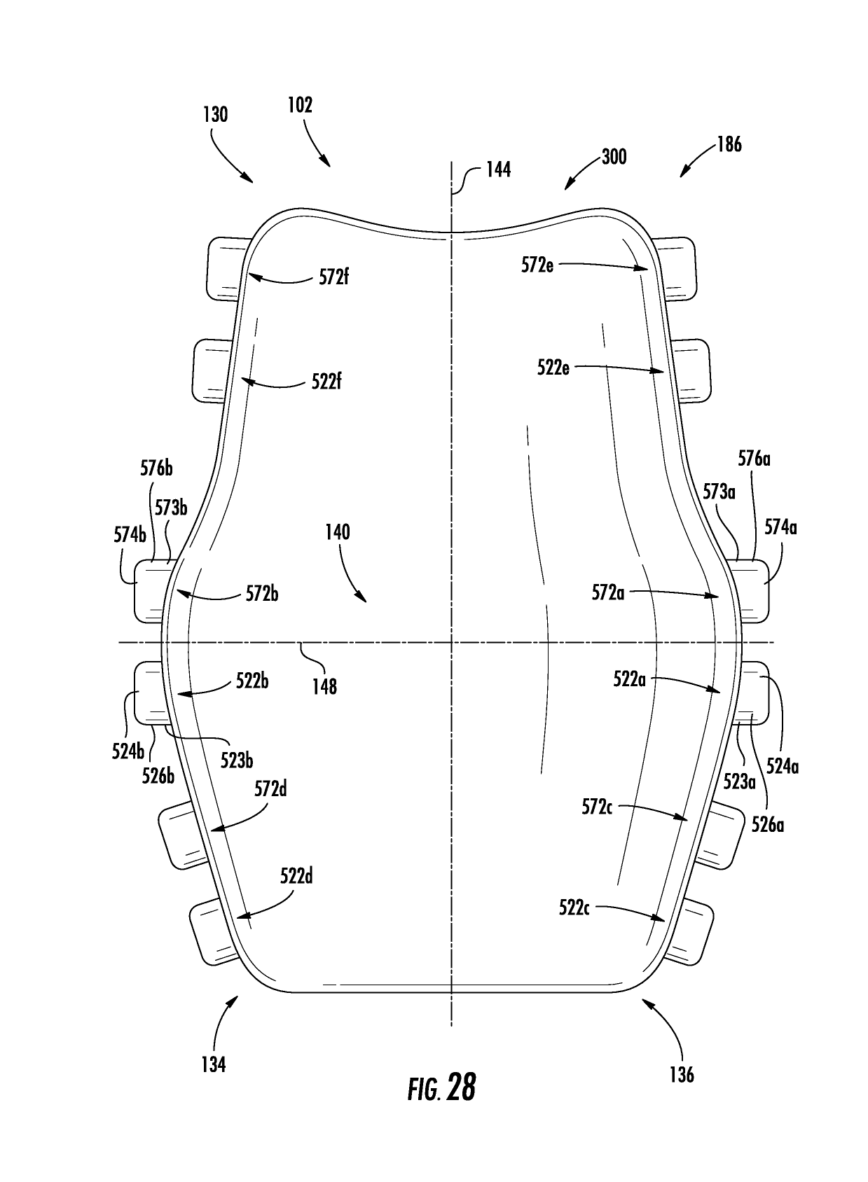

In an embodiment, projections 522 are located adjacent flange 112, and projections 372 are located adjacent flange 162. Projection 522a is adjacent the midsection 140 on the right side 136 of the first half 102, and includes a side portion 526a extending from a base 523a at the exterior surface 106, terminating at an upper portion 524a. Projection 522a has a rectangular cross-section. Projection 522b is adjacent the midsection 140 on the left side 134 of the first half 102, and includes a side portion 526b extending from a base 523b at the exterior surface 106, terminating at an upper portion 524b. Projection 522b has a rectangular cross-section. Projection 572a is adjacent the midsection 140 on the right side 186 of the second half 152, and includes a side portion 576a extending from a base 573a at the exterior surface 156, terminating at an upper portion 574a. Projection 572a has a rectangular cross-section. Projection 572b is adjacent the midsection 140 on the left side 184 of the second half 152, and includes a side portion 576b extending from a base 573b at the exterior surface 156, terminating at an upper portion 574b. Projection 572b has a rectangular cross-section. In an embodiment, upper portion 524a, 524b, 574a, and 574b have curved corners eliminating sharp edges that might puncture a covering. In FIGS. 28-31, projections 522a and 572a are shown offset and spaced from one another when the first half 102 and second half 152 are joined at the openings 110, 160. Advantageously, projection 572a allows a user to bias projection 572a away from the first half 102, disengaging engagement member 163 from engagement member 113 along the right side 136, thereby facilitating separation of halves 102, 152, and access to the object in the hollow interior. In addition, projections 522b and 572b are shown offset and spaced from one another when the first half 102 and second half 152 are joined at the openings 110, 160. Advantageously, projection 572b allows a user to bias projection 572b away from the first half 102, disengaging engagement member 163 from engagement member 113 along the left end 134, thereby facilitating separation of halves 102, 152, and access to the object in the hollow interior. Projection 522a is widely spaced from projection 522b, and projection 572a is widely spaced from projection 572b.

Projection 522c is on the bottom end 132 on the right side 136 of the first half 102, and includes the same structural features of projection 522a. Projection 522d on the bottom end 132 on the left side 134 of the first half 102, and includes the same structural features of projection 522a. Projection 522e is on the top end 130 on the right side 136 of the first half 102, and includes the same structural features of projection 522a. Projection 522f is on the top end 130 on the left side 134 of the first half 102, and includes the same structural features of projection 522a.

Projection 572c is on the bottom end 182 on the right side 186 of the second half 152, and includes the same structural features of projection 572a. Projection 572d is on the bottom end 182 on the left side 184 of the second half 152, and includes the same structural features of projection 572a. Projection 572e is on the top end 180 on the right side 186 of the second half 152, and includes the same structural features of projection 572a. Projection 572f is on the top end 180 on the left side 184 of the second half 152, and includes the same structural features of projection 572a.

Projections 552a, 552b, 552c, 552d, 552e, and 552f are widely spaced as to each other, and projections 572a, 572b, 572c, 572d, 572e, and 572f are widely spaced as to each other.

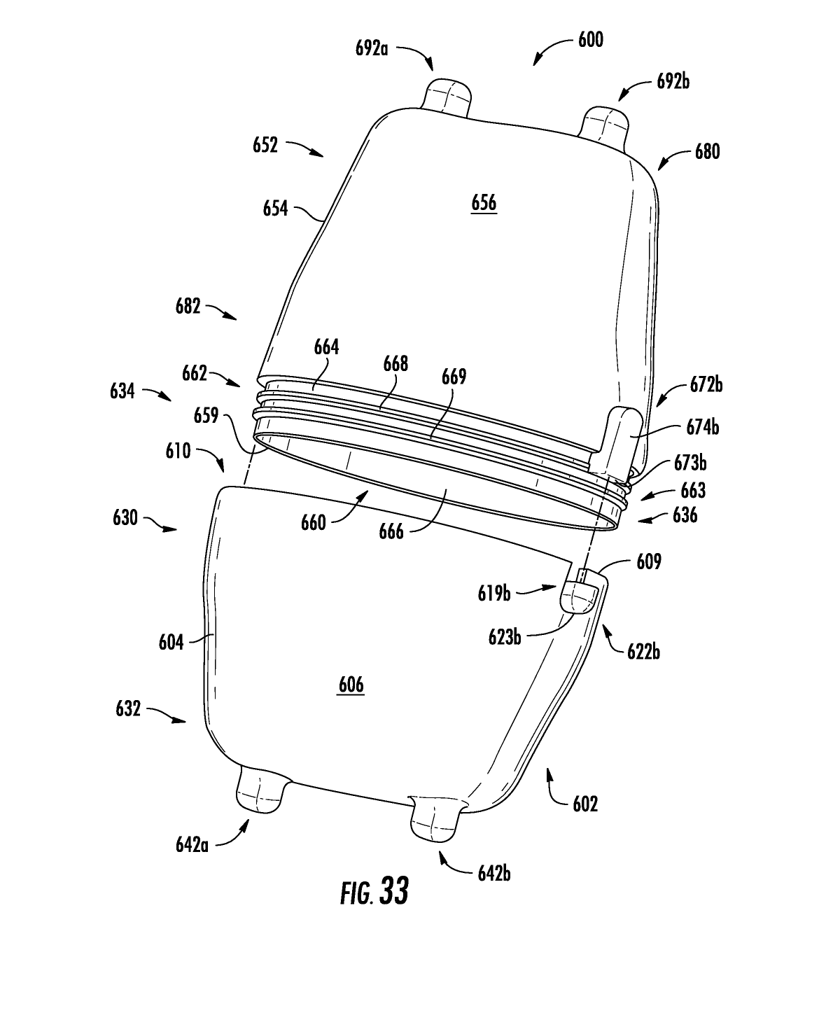

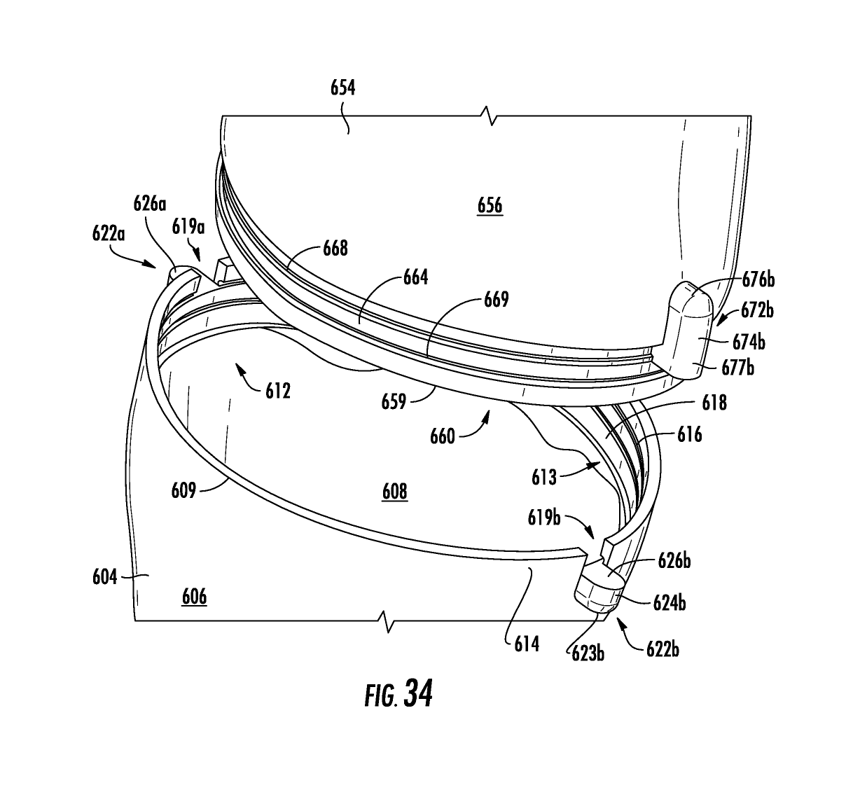

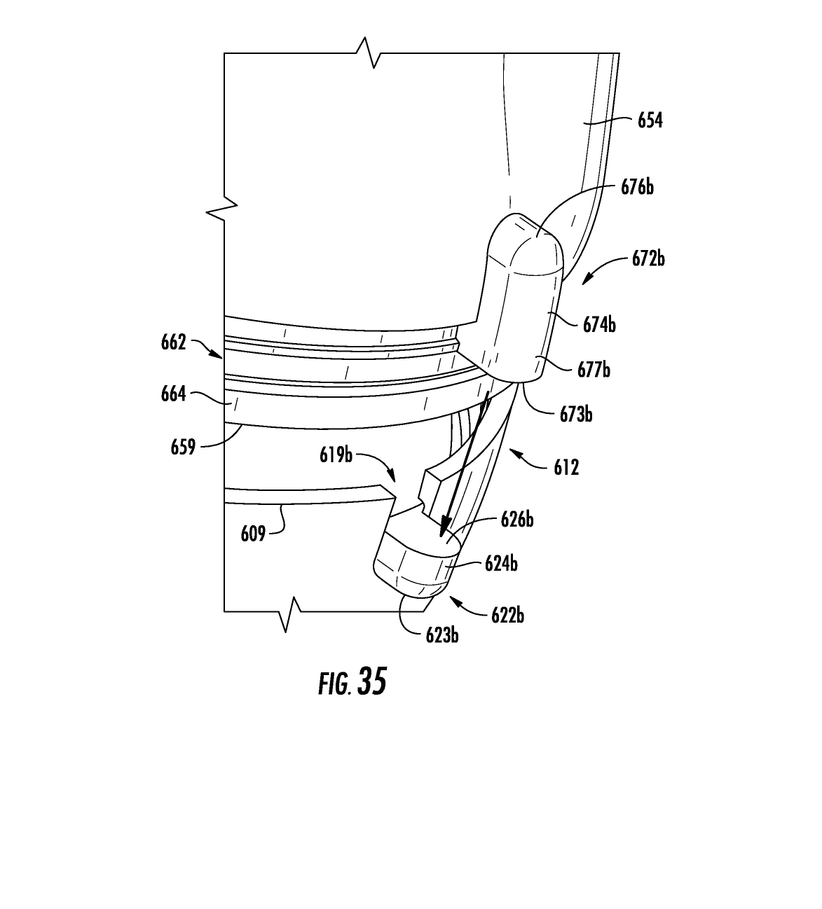

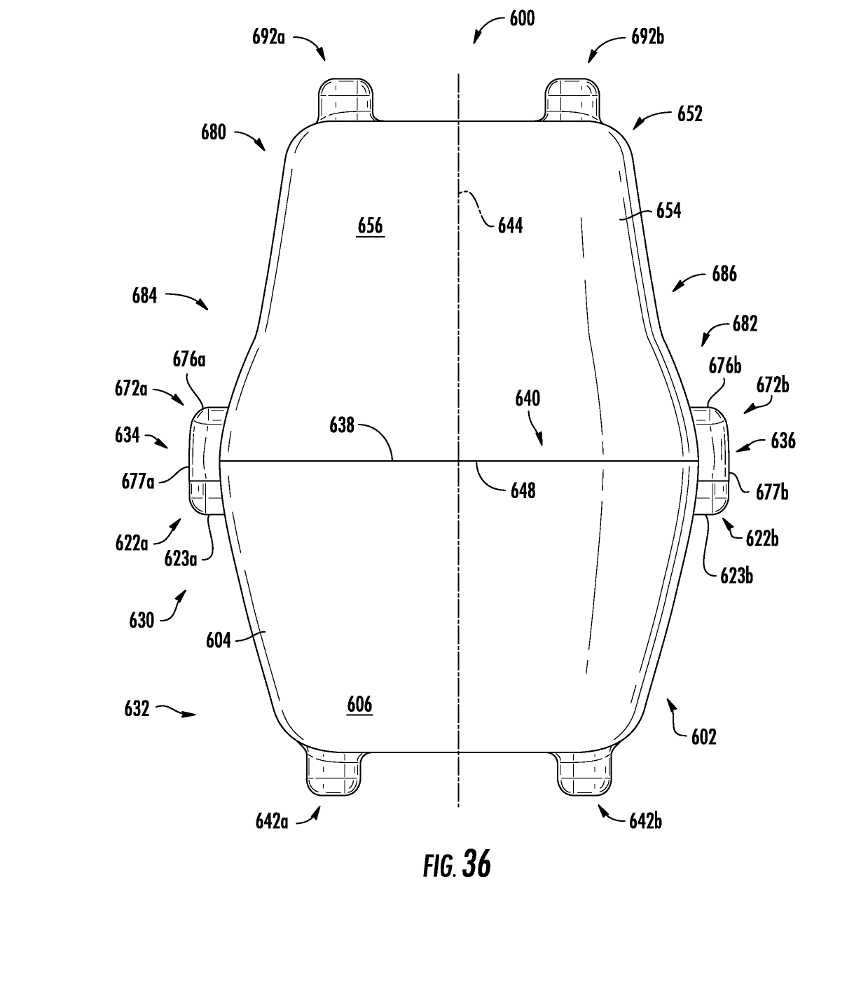

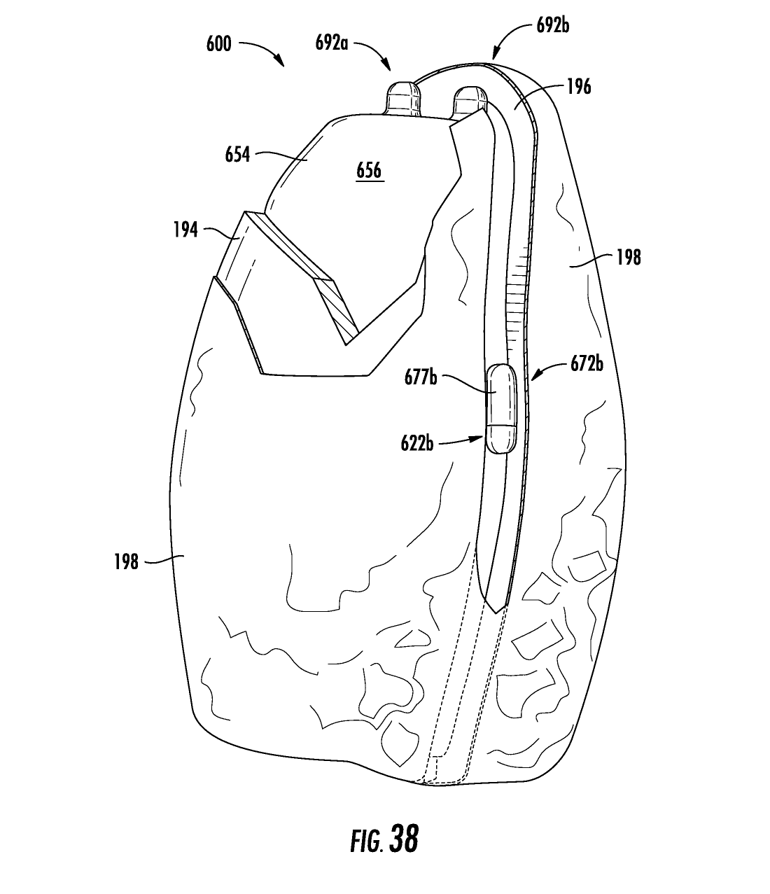

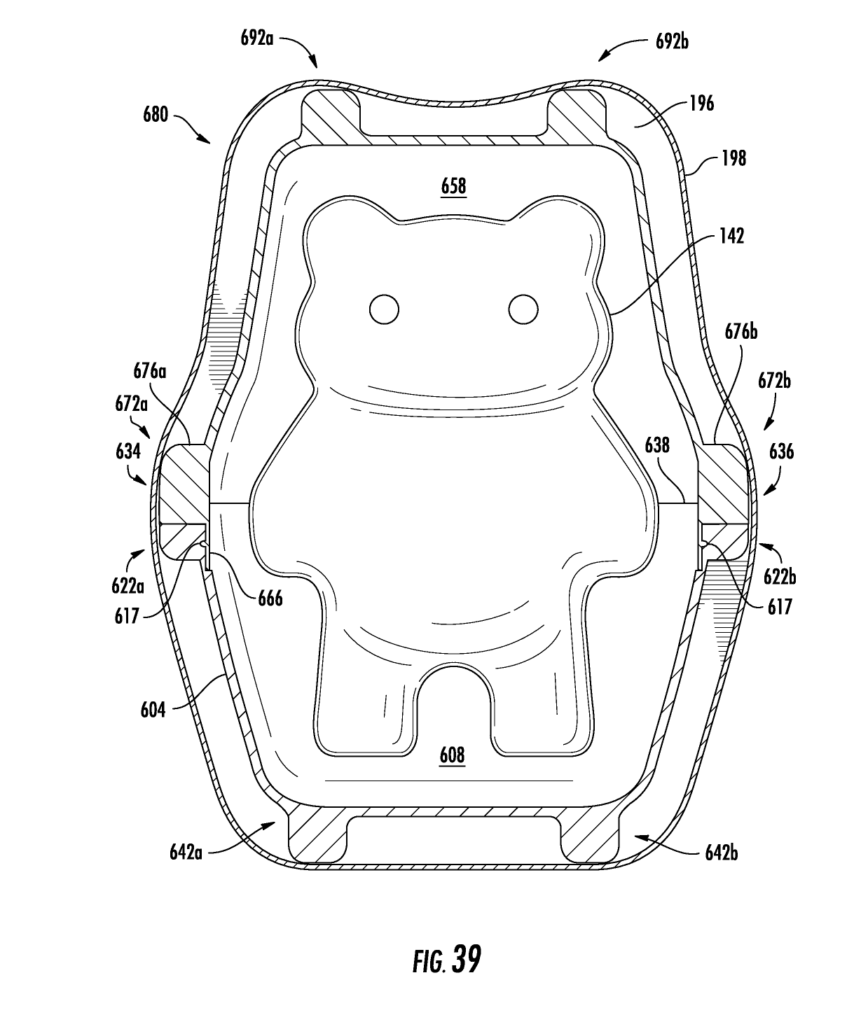

Referring to FIGS. 33-39, a capsule 600 having a longitudinal axis 644 greater than a transverse axis 648 includes a first half 602 and a second half 652 joined about a plane extending horizontally through the transverse axis 648 forming divisible resealable container. In FIGS. 33-35 the capsule 600 is shown in an unsealed configuration. In FIGS. 36-39 the capsule 60 is shown in a releasably connected or sealed configuration. In an embodiment, a first confectionary coating 194 at the exterior of the container 600 conforms to and covers half of the first half 602 and half of the second half 652 forming an edge adjacent a plane extending longitudinally through the longitudinal axis 644 between the left side 634 and right side 636, and an opposite second confectionary coating 196 conforms to and covers half of the first half 602 and half of the second half 652 forming an edge opposite the first confectionary coating 194 edge. The coatings 194 and 196 may be enclosed by an outer covering 198.

The first half 602 includes a body 604 with an exterior surface 606 and an interior surface 608 forming an upwardly open container. The body 604 forms a top end 630, a bottom end 632, a left side 634, and a right side 636. The body 604 forms a rim 609 at the top end 630 defining an opening 610 into an interior. A flange 612 at the rim 609 includes an engagement member 613. The second half 652 includes a body 654 with an exterior surface 656 and an interior surface 658 forming a downwardly open container. The body 654 forms a top end 680, a bottom end 682, a left side 684, and a right side 686. The body 654 forms a rim 659 at the bottom end 682 defining an opening 660 into an interior. A flange 662 at the rim 659 includes an engagement member 663 that compliments engagement member 613. The first half 602 and second half 652 are joined at the openings 610, 660 forming a joint 638 in the divisible container. The capsule 600 has a midsection 640 that has a transverse cross-sectional width between the left side 634 and right side 636 greater than the transverse cross-sectional width at the top end 680 and bottom end 632.

In an embodiment, engagement member 613 is an upper groove 616 and lower groove 617 formed by an inner surface 618 of the flange 612 opposite an outer surface 614 of the flange 612, and engagement member 663 is an upper ridge 668 and lower ridge 669 formed by an outer surface 664 of the flange 662 opposite an inner surface 666 of the flange 662. In an embodiment, the lower groove 617 is continuous about the inner surface 618, and the upper groove 616 is continuous but interrupted by a gap 619a at the left side 634 and a gap 619b at the right side 636. In an embodiment, the lower ridge 669 is continuous about the outer surface 614, and the upper ridge 668 is continuous but interrupted by a lower extension 677a of the projection 672a at the left side 684 and a lower extension 677b of projection 672b at the right side 686.

In an embodiment, engagement member 613 is one or more ridges extending from the inner surface 618 of the flange 612 opposite an outer surface 614 of the flange 612, and engagement member 663 is one or more grooves extending into the outer surface 664 of the flange 662 opposite an inner surface 666 of the flange 662.

The first and second halves 602, 652 include one or more widely spaced projections integrally formed with the respective body providing an indication to a user that an object is beneath the confectionary coatings 194, 196. In an embodiment, the first half 602 includes rectangular projections 622 formed from the flange 612 at the midsection 640, and rectangular projections 642 located adjacent the bottom end 632, and the second half 652 includes rectangular projections 672 located at the midsection 640 adjacent the flange 662, and rectangular projections 692 located adjacent the top end 680.

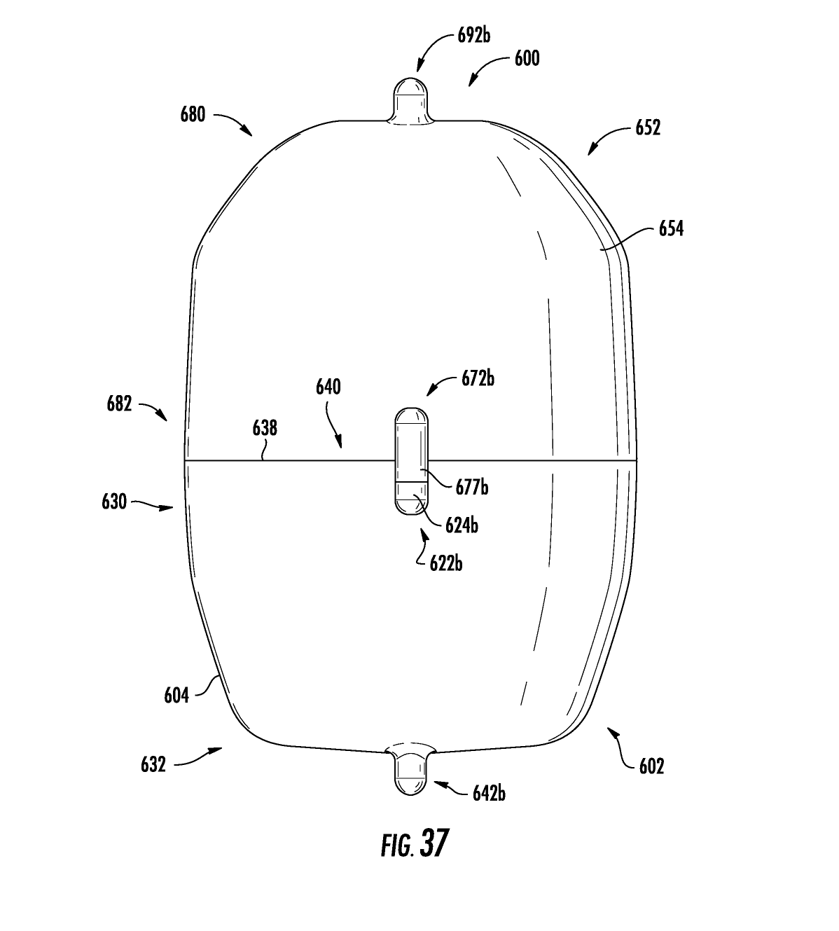

Referring to FIG. 36-37, rectangular projection 622a is shown at the midsection 640 adjacent the flange 612 on the left side 634 of the first half 602. The projection 622a extends from the exterior surface 606 terminating at an upper portion 624a. In an embodiment, the upper portion 624a has curved corners eliminating sharp edges that might puncture a covering. Projection 622a has a generally rectangular cross-section, and forms an upper edge 626a and an opposite lower edge 623a with opposing sidewalls there between. The upper edge 626a forms the bottom of a gap 619a, and is adjacent a lower edge 673a of rectangular projection 672a when the halves 602, 652 are joined. Rectangular projection 622b is shown at the midsection 640 adjacent the flange 612 on the right side 636 of the first half 602. The projection 622b extends from the exterior surface 606 terminating at an upper portion 624b. In an embodiment, the upper portion 624b has curved corners eliminating sharp edges that might puncture a covering. Projection 622b has a generally rectangular cross-section, and forms an upper edge 626b and an opposite lower edge 623b with opposing sidewalls there between. The upper edge 626b forms the bottom of a gap 619b, and is adjacent a lower edge 673b of rectangular projection 672b when the halves 602, 652 are joined.

The first half 602 includes rectangular projections 642a and 642b at the bottom end 632 similar in location to projections 422a and 422b.

Rectangular projection 672a is shown at the midsection 640 adjacent the flange 662 on the left side 684 of the second half 652. The projection 672a extends from the exterior surface 664 terminating at an upper portion 674a. In an embodiment, the upper portion 674a has curved corners eliminating sharp edges that might puncture a covering. Projection 672a has a generally rectangular cross-section, and forms an upper edge 675a and an opposite lower edge 673a with opposing sidewalls there between. The lower extension 677a forms the lower edge 673a, and is adjacent the upper edge 626a when the halves 602, 652 are joined. Rectangular projection 672b is shown at the midsection 640 adjacent the flange 662 on the right side 686 of the second half 652. The projection 672b extends from the exterior surface 664 terminating at an upper portion 674b. In an embodiment, the upper portion 674b has curved corners eliminating sharp edges that might puncture a covering. Projection 672b has a generally rectangular cross-section, and forms an upper edge 675b and an opposite lower edge 673b with opposing sidewalls there between. The lower extension 677b forms the lower edge 673b, and is adjacent the upper edge 626b when the halves 602, 652 are joined.

The second half 652 includes rectangular projections 692a and 692b at the top end 680 similar in location to projections 492a and 492b.

Projections 622a, 622b, 642a, and 642b are widely spaced with respect to each other, projections 672a, 672b, 692a, and 692b are widely spaced with respect to each other, and the aforementioned projections are aligned about the exterior of the capsule 600 along the plane extending longitudinally through the longitudinal axis 644 between the left side 634 and right side 636.

The first half 602 and second half 652 are joined by interlocking the lower ridge 669 with the lower groove 617, and the upper ridge 668 with the upper groove 616. When the first half 602 and second half 652 are joined, lower extension 677a is seated in gap 619a, and lower extension 677b is seated in gap 619b whereby projection 622a is opposite projection 672a, and projection 622b is opposite projection 672b. Interruption of the upper groove 616 by gaps 619a-b and interruption of upper ridge 668 by lower extensions 677a-b allows a deeper connection between the first half 602 and second half 652 limiting rotational movement of the halves 602, 652 and any resulting damage to the confectionary coatings 194, 196 and the covering 198.

The halves 602, 652 are separated by squeezing together opposite sides of the capsule 600 at the midsection 640 between the left side 634 and the right side 636.

While the present disclosed subject matter has been illustrated by a description of various embodiments and while these embodiments have been described in considerable detail, it is not the intention of applicant to restrict or in any way limit the scope of the appended claims to such detail. Additional advantages and modifications will readily appear to those skilled in the art. The disclosed subject matter in its broader aspects is therefore not limited to the specific details, representative apparatus and method, and illustrative examples shown and described. Accordingly, departures may be made from such details without departing from the spirit or scope of applicant's general disclosed subject matter.

As required, detailed aspects of the disclosed subject matter are disclosed herein; however, it is to be understood that the disclosed aspects are merely exemplary of the disclosed subject matter, which may be embodied in various forms. Therefore, specific structural and functional details disclosed herein are not to be interpreted as limiting, but merely as a basis for the claims and as a representative basis for teaching one skilled in the art how to variously employ the disclosed technology in virtually any appropriately detailed structure.

Certain terminology used in the description is for convenience in reference only and shall not be limiting. For example, up, down, front, back, right, and left refer to the disclosed subject matter as orientated in the view being referred to. The words, “inwardly” and “outwardly” refer to directions toward and away from, respectively, the geometric center of the aspect being described and designated parts thereof. The terminology will include the words specifically mentioned, derivatives thereof, and words of similar meaning Like references numbers denote like features, components, or elements throughout the various embodiments.

1. A hollow capsule having a longitudinal axis greater than a transverse axis, comprising:
a first half extending between a top end and a bottom end forming an exterior surface, an interior surface, and a rim defining an opening into an interior;
a second half extending between a top end and a bottom end forming an exterior surface, and interior surface, and a rim defining an opening into an interior;
a first projection extending from a left side of the first half exterior surface adjacent the rim;
a second projection extending from a left side the second half exterior surface adjacent the rim; and
wherein the first half and the second half are releasably connected at their openings forming a sealed capsule with a midsection disposed between the first half and second half, and wherein the first projection is disposed adjacent the second projection at the midsection.

2. The capsule of claim 1, further comprising:
a first confectionary coating on the first half; and
a second confectionary coating on the second half.

3. The capsule of claim 2, further comprising a covering about the exterior of the first and second confectionary coating.

4. The capsule of claim 1, wherein the first projection and the second projection have a generally rectangular cross-section.

5. The capsule of claim 4, wherein:
the first and second projections terminate at an outer edge; and
the outer edge is generally parallel with the exterior surface.

6. The capsule of claim 1, wherein the first projection and the second projection have a circular cross-section.

7. The capsule of claim 6, wherein the first projection and the second projection are spherical.

8. The capsule of claim 6, wherein the first projection and the second projection are tubular.

9. The capsule of claim 1, further comprising a plurality of widely spaced projections on the first and second halves along a plane extending longitudinally through the capsule.

10. The capsule of claim 1, further comprising:
wherein the midsection is along a plane extending longitudinally through the capsule between the left side and the longitudinal axis;
a third projection extending from the first half exterior surface adjacent the rim at the top end;
a fourth projection extending from the second half exterior surface adjacent the rim at the bottom end; and
wherein the third projection is widely spaced from the first projection, and the fourth projection is widely spaced from the second projection.

11. The capsule of claim 10, wherein:
the third projection is adjacent the top end; and
the fourth projection is adjacent the bottom end.

12. The capsule of claim 10, wherein:
the third projection extends from the top end; and
the fourth projection extends from the bottom end.

13. The capsule of claim 1, further comprising:
wherein the midsection is along a plane extending longitudinally through the capsule between the left side and the longitudinal axis;
a third projection extending from the first half exterior surface adjacent the top end;
a fourth projection extending from the second half exterior surface adjacent the top end;
wherein the third projection is disposed adjacent the fourth projection when the first half and second half are connected; and
wherein the third projection is widely spaced from the first projection, and the fourth projection is widely spaced from the second projection.

14. The capsule of claim 13, wherein the third projection and the fourth projection have a circular cross-section.

15. The capsule of claim 1, wherein:
the midsection is along a plane extending transversely through the capsule;
the first half rim forms a gap at the left side;
the second projection forms a lower extension; and
the lower extension is disposed within the gap when the first half and second half are connected at their openings.

16. The capsule of claim 15, further comprising:
a first half flange formed at the first half opening, comprising an interior surface forming an upper groove and a lower groove;
wherein the upper groove is interrupted by the first half gap;
a second half flange formed at the second half opening, comprising an exterior surface forming an upper ridge and a lower ridge; and
wherein the upper ridge is interrupted by the lower extension.

17. The capsule of claim 1, further comprising:
a first confectionary coating at the exterior of the capsule covering half of the capsule and forming an edge adjacent a longitudinal plane extending through the longitudinal axis;
a second confectionary coating at the exterior of the capsule covering half of the capsule and forming an edge adjacent a longitudinal plane extending through the longitudinal axis;
wherein the first and second projections are disposed between the first and second confectionary coatings; and
a covering about the exterior of the first and second confectionary coatings.

18. A hollow capsule having a longitudinal axis greater than a transverse axis, comprising:
a first half extending between a bottom end and a top end forming an upwardly open container having an exterior surface, an interior surface, and a rim at the top end defining an opening into an interior;
a first flange formed at the first half opening, comprising an interior surface forming an upper groove, a lower groove, and a gap interrupting the upper groove;
a second half extending between a top end and a bottom end forming a downwardly open container having an exterior surface, an interior surface, and a rim at the bottom end defining an opening into an interior;
a second flange formed at the second half opening, comprising an exterior surface forming an upper ridge and a lower ridge;
a first projection extending from the first half exterior surface adjacent the rim forming a bottom to the gap;
a second projection extending from the second half exterior surface adjacent the rim forming a lower extension interrupting the upper ridge; and
wherein the first half and the second half are releasably connected at their openings forming a sealed capsule with a midsection disposed between the first half top end and second bottom top end, whereupon the first projection is received within the gap.

19. The capsule of claim 18, further comprising:
a longitudinal plane extending through the longitudinal axis and the first projection;
a first confectionary coating at the exterior of the capsule covering the first half and the second half forming an edge adjacent the longitudinal plane;
a second confectionary coating at the exterior of the capsule covering the first half and the second half forming an edge adjacent the longitudinal plane; and
wherein the first and second projections are disposed along the longitudinal plane between the first and second confectionary coatings.

20. The capsule of claim 19, further comprising a covering about the exterior of the first and second confectionary coatings.

21. The capsule of claim 18, further comprising:
a longitudinal plane extending through the longitudinal axis and the first projection;
a third projection extending from the first half exterior surface at the bottom end;
a fourth projection extending from the second half exterior surface at the top end;
wherein the first, second, third, and fourth projection are disposed along the longitudinal plane; and
wherein the third projection is widely spaced from the first projection, and the fourth projection is widely spaced from the second projection.

22. A capsule having a longitudinal axis greater than a transverse axis, comprising:
a first half extending between a top end and a bottom end forming an exterior surface, an interior surface, and a rim defining an opening into an interior;
a second half extending between a top end and a bottom end forming an exterior surface, and interior surface, and a rim defining an opening into an interior;
a first projection extending from a left side of the first half exterior surface adjacent the rim;
a second projection extending from a left side the second half exterior surface adjacent the rim;
wherein the first half and the second half are releasably connected at their openings forming a sealed capsule with a midsection disposed between the first half and second half, and wherein the first projection is opposite the second projection at the midsection;
a longitudinal plane extending through the longitudinal axis and the left side;
a first confectionary coating at the exterior of the capsule covering the first half and the second half forming an edge adjacent the longitudinal plane;
a second confectionary coating at the exterior of the capsule covering the first half and the second half forming an edge adjacent the longitudinal plane;
wherein the first and second projections are disposed along the longitudinal plane between the first and second confectionary coatings; and
a covering about the exterior of the first and second confectionary coatings.

23. The capsule of claim 22, further comprising a plurality of widely spaced projections at the exterior of the first and second halves aligned along the longitudinal plane extending through the longitudinal axis and the left side.

24. The capsule of claim 22, wherein:
the first half rim forms a gap at the left side;
the second projection forms a lower extension; and
the lower extension is disposed within the gap when the first half and second half are connected by their openings.

25. The capsule of claim 24, further comprising:
a first half flange formed at the first half opening, comprising an interior surface forming an upper groove and a lower groove;
wherein the upper groove is interrupted by the first half gap;
a second half flange formed at the second half opening, comprising an exterior surface forming an upper ridge and a lower ridge; and
wherein the upper ridge is interrupted by the lower extension.

26. The capsule of claim 22, further comprising an object disposed within the first half and second half interior.
